(19) United States
(12) Patent Application Publication
(10) Pub. No.: US 2026/0344643 A1
(43) Pub. Date: Nov. 5, 2026

(54) PESTICIDE SPREADER AND SPRAYER VEHICLE

(71) Applicant: L.T.R. Design, Inc., Pittsboro, IN (US)

(72) Inventor: Thomas M. Rich, Pittsboro, IN (US)

(21) Appl. No.: 19/665,536

(22) Filed: May 1, 2026

Related U.S. Application Data
(60) Provisional application No. 63/798,279, filed on May 1, 2025.

(51) Int. Cl. A01M 11/00

(52) U.S. Cl. CPC A01M 11/00

(57) ABSTRACT

An all-wheel drive and all-wheel steer spreader/sprayer and maintenance vehicle. The vehicle further includes a motor and a hydraulic system. The hydraulic system includes a first hydraulic cylinder and a second hydraulic cylinder in communication with one another. In one embodiment, the first and second hydraulic cylinders are arranged to articulate wheels in opposing directions such that when the first hydraulic cylinder articulates a front wheel in a first direction the second hydraulic cylinder articulates a rear wheel in a second direction that is opposite the first direction. In another embodiment, the first and/or second hydraulic cylinder is a rephasing cylinder. Further, the vehicle may include an articulatable hopper gate and translatable impeller to control the broadcast direction of product being spread from the spreader assembly, sliding tanks on rails, and modular rakes/drags with hydraulic lifts.

### CROSS-REFERENCE TO RELATED APPLICATION

This application claims the benefit of U.S. Provisional Application No. 63/798,279 filed May 1, 2025 the entirety of which is hereby incorporated by reference.

### BACKGROUND

Spreading and/or spraying pesticide is common in the lawn care industry. Existing spreader/sprayer vehicles include zero turn vehicles. Most zero turn vehicles use a set of fixed (i.e., non-articulable) drive wheels in the rear, generally near the engine and the operator, and a set of non-driven castors in the front. As compared to rear wheel drive and front wheel steer lawn tractors, zero turn vehicles are popular due to their often smaller turning radius.

While they have many benefits, zero turn vehicles, however, have drawbacks on certain terrain compared to lawn tractors. When turning sharply with a zero turn vehicle it is common for at least one of the tires to slip along the driving surface (e.g., turf). Tire slip can damage turf surfaces particularly if the tire has a relatively aggressive tread and/or the turf is relatively soft. If on a harder surface such as pavement, slip can prematurely wear and/or damage the drive tires.

While some level of slip may be acceptable, slip can result in a loss of traction which, depending on the circumstances, can be dangerous. If, for example, a loss of traction is experienced on a hill with a zero turn vehicle, the vehicle may veer from the intended path of travel and/or the operator may have little or no control over steering and/or propulsion. While some improvements have been made in this area (e.g., locking front castors as disclosed in U.S. Pat. No. 8,292,112 to Thomas Rich) there is still a desire for improvement.

Further, existing spreader/sprayer vehicles include spreaders that may waste product (e.g., fertilizer) by spreading product on undesirable areas, such as sidewalks, roads, buildings, or by reapplying product to areas that have already been covered. To help alleviate this problem, some spreader/sprayer vehicles utilize shields that are configurable to block the broadcast of product in a particular direction. However, this solution comes with its own problems (e.g., heavier concentration of product in certain areas as the product that contacts the shield may fall into a smaller area than other product being broadcast). Thus, there is still a desire for improvement in this area as well.

Accordingly, there is a need for improvement in this field.

### SUMMARY

The present disclosure pertains generally to maintenance and utility vehicles for spreading and/or spraying pesticide (including herbicide), as well as soil preparation, grading, aeration, compaction, and other ground maintenance tasks. The vehicles have front and rear wheel steering. Preferably, all steerable wheels are driven. More preferably, all driven wheels are steerable.

The vehicles include a frame. Connected to the frame, such as through one or more front axles, is a set of front wheels. Spaced rearward of the front set of wheels is a set of rear wheels. The rear set of wheels may be connected to the frame through one or more rear axles. In one example, the front set of wheels have a smaller diameter than the rear set of wheels. In another example, the front and rear sets of wheels may have the same diameter or the front set of wheels may have a larger diameter than the rear set of wheels. Additionally or alternatively, the front wheels and rear set of wheels may have different sized wheel motors to drive the wheels.

The vehicle is propelled by a powertrain system. The powertrain system includes a motor positioned over the forward wheels to optimize weight distribution and a hydraulic system. The motor can be an internal combustion engine (Otto or Diesel cycle) and/or an electric motor. In instances including an electric motor, the vehicle may include one or more batteries for powering the electric motor. The motor is configured to supply power to the hydraulic system.

The hydraulic system is arranged to articulate and drive wheels of the front and rear set of wheels. The hydraulic system receives power from the powertrain motor to power one or more hydraulic pumps. The one or more hydraulic pumps pressurize one or more hydraulic lines leading to one or more steering circuits of the steering system and/or one or more wheel-motor circuits.

A steering system articulates the front and rear sets of wheels in opposite directions relative to the frame. Preferably, the steering system articulates the front and rear sets of wheels equally relative to the frame. For example, if the front wheels articulate 30° relative to a longitudinal axis of the frame, the rear wheels preferably articulate 30° in the opposite direction relative to the longitudinal axis.

Articulation of the front and rear sets of wheels may be a function of vehicle speed. For example, in speeds over 20 kilometers per hour, articulation of the rear set of wheels may be reduced and/or disabled relative to the front set of wheels. The front and rear sets of wheels may articulate equally if the vehicle is traveling at slower speeds (e.g., under ten kilometers per hour).

The steering system can include one or more hydraulic piston cylinders for articulating the front set of wheels and the rear set of wheels. For example, the steering system can include a first hydraulic piston cylinder for articulating the front set of wheels and a second hydraulic piston cylinder for actuating the rear set of wheels. In one embodiment, the hydraulic cylinders may be rephasing cylinders connected in series so that the volume of hydraulic fluid exiting one cylinder (e.g., the first cylinder) is equal to the volume of hydraulic fluid entering the other cylinder (e.g., the second cylinder). Advantageously, such an arrangement may be used to maintain the front and rear set of wheels at the same turning angle, albeit in opposite directions.

The vehicle may utilize Ackerman steering. In some instances, the vehicle may be selectively configurable for only front wheel steering and/or rear wheel steering. Preferably, in such instances, the vehicle may lock the unsteered wheels into a fixed position. For example, the user may place the rear set of wheels into a desired position and actuate a lock to fix the rear set of wheels at the position. Disabling the all-wheel steer and converting the vehicle to front wheel steer only may be advantageous for higher speed operation.

Preferably, the front wheels are mounted on a front axle that is pivotable relative to the frame. The axle is preferably pivotably about a longitudinal axis extending from the front to the rear of the vehicle. More preferably, first and second front wheels are mounted on opposing ends of the front axle and the front axle is pivotably mounted to the frame between the first and second front wheels. Accordingly, when one of the front wheels pivots upwards relative to the frame the other wheel may pivot downwards. Advantageously, such an arrangement can aid in keeping the front wheels in contact with the surface beneath the vehicle. Additionally, supporting the front wheels on an axle pivotably mounted to the frame can aid in equalizing ground pressure between the front wheels so that an individual wheel is less likely to lose traction or leave a rut in wet turf.

Located adjacent each of the wheels is an outer joint kingpin. The outer joint kingpin serves as a pivot point for each individual wheel. In steering, a hydraulic cylinder applies force to the wheel (e.g., via a tie rod and/or a steering knuckle) to articulate the wheel about an axis defined by the outer joint kingpin. In other embodiments, the outer joint kingpin may be located above the wheels. Advantageously, this arrangement provides for additional space for other components and/or allows for a smaller overall width of the vehicle. Preferably vehicles of the present disclosure have an overall width of less than one meter and, more preferably less than 915 mm. Combinations of arrangements is also contemplated. For example, the rear wheels may have outer joint kingpins that are adjacent to the wheels while the front outer joint kingpins may be located above the front wheels.

The driven wheels of the vehicle are powered by one or more hydraulic wheel motors of the one or more wheel-motor circuits. The hydraulic wheel motors are generally connected to the hydraulic system via one or more hoses (not shown for ease of illustration). Preferably each driven wheel has a dedicated a hydraulic wheel motor.

The hydraulic wheel motors can power each of the wheels independently. Hydraulic wheel motors may be on separate and/or the same hydraulic wheel-motor circuits as other hydraulic wheel motors. For example, if wheel motors are on different wheel-motor circuits then the motors and corresponding wheels may turn at different speeds. This may be advantageous, for example, during a turn as the outer wheels in the turn may turn at a greater speed than the inner wheels. It is contemplated, however, that the hydraulic wheel motors of the front wheels may be in the same hydraulic wheel-motor circuit and/or the wheel motors of the rear wheels may be in the same hydraulic wheel-motor circuit. In some instances, a hydraulic wheel-motor circuit may supply hydraulic wheel motors of the front and rear wheels. For example, a single hydraulic wheel motor circuit may supply all driven wheel motors.

Portions of the one or more hydraulic circuits may include valving to allow an operator to selectively bypass and/or close portions of the hydraulic circuit. For example, the one or more hydraulic circuits may include valving to allow an operator to selectively disconnect the hydraulic piston cylinder for steering the rear wheels. As explained herein, such an arrangement may be desirable during higher speeds of operation when an operator desires only front-wheel steering.

The motor may provide rotational power to a hydraulic pump via a direct drive and/or pully or gear system. For example, the motor may turn a first pully that is connected to a second pully via a belt (not shown for ease of illustration). Rotation of the second pully generates pressure within the pump which causes hydraulic fluid to flow from the pump into the valve. The valve controls the location and flow of the fluid. For example, the valve may send pressurized fluid to one or more hydraulic cylinders and/or one or more hydraulic motors. Generally, the valve may be connected to the hydraulic cylinders and/or hydraulic motors via one or more hoses (not shown for ease of illustration). In other embodiments, the hydraulic system may include two or more valves.

Valving of the one or more hydraulic circuits may be controlled via a steering control and/or speed control. The steering control may be a round steering wheel or a steering yoke. Preferably the steering control is operable using only a single hand. Speed control may be a lever or knob, just to name a few non-limiting examples. Accordingly, an operator may control the vehicle with one hand controlling steering and the other hand controlling another aspect of the vehicle such as speed and product(s) spreading and/or spraying (e.g., controlling broadcast direction and/or distance and/or operating a spray wand). Alternatively, the vehicle may be controlled, at least in part, by one or more foot controls. For example, the vehicle may include a foot pedal configured to control the direction (e.g., forward/reverse) and/or speed of the vehicle and/or the spreading and/or spraying of product(s). Advantageously, this arrangement can allow for an operator to steer the vehicle with one hand, control the direction (forward/reverse) and/or speed of the wheels by the foot control, and/or operate a hand-held sprayer wand of the sprayer assembly, simultaneously.

The vehicle may include a standing platform rearward of the steering and speed controls. During operation of the vehicle the user may stand on the platform and operate the controls. Located adjacent to and forward of the platform is a padded surface. Advantageously, a user may lean against the padded surface for additional support while standing on the platform. In other examples, the vehicle may include a seat and/or saddle for a user instead of the standing platform. Foot controls described herein may be recessed in, positioned above, and/or positioned adjacent to the standing platform.

The vehicle includes a spreader and/or sprayer system. A spreader system can include a spreader assembly. The spreader assembly includes a hopper and a spreader. Generally, the hopper drops product on to the spreader for dispersion. As should be appreciated, the hopper may drop product at different rates (kg/min). The rate at which product drops from the hopper is preferably controlled. More preferably, the rate at which product drops from the hopper is controlled as a function of speed of the vehicle, the desired amount of product to be dispersed for a given area (e.g., kg of product per hectare), and/or the broadcast distance (e.g., speed of the spreader). For example, the hopper may drop product at a higher rate when the vehicle is traveling at a higher speed and/or at a lower rate when the vehicle is traveling at a lower speed. Similarly, the spreader may operate at a user defined variable speed. For example, the spreader may operate at a faster speed (e.g., to broadcast product over a greater area) and/or a slower speed (e.g., to broadcast product over a smaller area). Controlling the rate at which product drops from the hopper may be accomplished by the use of an electronically controlled actuating gate configured to control the rate at which produce is released from the hopper onto/into the spreader.

The spreader assembly is preferably configurable by an operator when s/he is standing on the standing platform to control the broadcast distance and/or direction of product. For example, the position of the spreader/impeller relative to the hopper outlet is preferably configurable by an operator when s/he is standing on the standing platform. By moving the spreader/impeller relative to the hopper outlet, product exiting the hopper may land on a different portion of the spreader/impeller and, thereby, change the direction, area, and/or distance the product is broadcast.

The spreader/impeller is preferably translatable relative to the hopper outlet, such as by an offset attachment to a rotating pivot point. The rotating pivot point may be electronically controlled by operator inputs. By rotating the pivot point, the offset impeller may move horizontally such that the broadcast direction and/or area of the product is altered. For example, by moving the impeller, the broadcast direction of the product can be concentrated to a desired area (i.e., left or right). Advantageously, this arrangement allows for product to be dispersed over desirable areas while avoiding undesirable areas (e.g., houses, streets, sidewalks, areas where product has already been spread, etc.). Further, the impeller/spreader may preferably include a plurality of guide vanes. The angles of the plurality of guide vanes may optionally be altered relative to the center of the impeller. This provides additional modifications to allow an operator to alter the broadcast pattern of the product during use of the spreader assembly.

The sprayer system may include a sprayer assembly. The sprayer assembly can comprise one or more tanks, a boom sprayer, and/or a hose and wand. The one or more tanks may include a first tank and a second tank. In some examples, the tanks may include a fill gauge. The fill gauge may be used to indicate the volume of liquid within the tank. The tanks are in fluid communication with the boom sprayer and/or hose and wand. The one or more tanks may include the same liquid and/or different liquids. In some examples, the vehicle may include one or more valves to selectively connect one or more tanks with the boom sprayer and/or hose and wand. The boom sprayer is preferably located forward of the front set of wheels and disperses liquid product in front of the vehicle during operation. The hose and wand enable a user to apply spot treatments and/or reach areas beyond the immediate area of the vehicle.

Preferably, one or more of the tanks of the sprayer system are selectively slidable laterally away from the vehicle chassis on a track or rail system, pivotable, or otherwise rotatable away from the vehicle to aid in maintenance. The pivot point(s) for rotation of the tank(s) may be located near the rear wheel. Rotation of the tank about the pivot point allows an operator to rotate the tank from a first position into a second position. Advantageously, rotating the tank into the second position allows for easy access to interior of the vehicle for maintenance purposes (e.g., changing an oil filter of the engine). The tank may include a support leg that is selectively extendable to engage the ground and support weight of the tank while the tank is in the second position. Further, the tank may include a locking mechanism to lock the tank in the first position to resist the tank from transitioning into the second position during operation of the vehicle.

In a sliding tank embodiment, one or more tanks (e.g., for water, fuel, pesticide, or other materials) are mounted on a chassis-integrated track or rail system allowing lateral sliding away from the vehicle body. The track comprises parallel rails with locking pins or hydraulic locks to secure the tank in an operational position. A hydraulic assist cylinder or manual crank may facilitate sliding, enabling full access to chassis components without disassembly. This reduces maintenance time compared to fixed tanks, as an operator and/or repair person can inspect/replace components without having to completely remove the tanks from the vehicle. Variations include single-tank slides for compact vehicles or multi-tank arrays with independent rails for larger models, all integrated with the frame without altering core steering/drive systems.

While the vehicle has been described as having four wheels, the vehicle may include more or fewer wheels. The vehicle further supports diverse ground-engaging attachments via modular quick-release couplers, hydraulic lifting arms, and optimized weight distribution via forward engine placement, enabling customization for equine arenas, golf courses, and more, as detailed below.

Other aspects, objectives, and advantages of the present disclosure will become more apparent from the following detailed description when taken in conjunction with the accompanying drawings. Further forms, objects, features, aspects, benefits, advantages, and examples of the present disclosure will become apparent from a detailed description and drawings provided herewith.

### BRIEF DESCRIPTION OF THE DRAWINGS

FIG. 1 is a perspective view of a spreader/sprayer vehicle.

FIG. 2 is a perspective view of another embodiment of a spreader/sprayer vehicle.

FIG. 3 is another perspective view of the spreader/sprayer vehicle of FIG. 2.

FIG. 4 is a front view of the spreader/sprayer vehicle of FIG. 1.

FIG. 5 is a front perspective view of another embodiment of a spreader/sprayer vehicle.

FIG. 6 is a side perspective view of the spreader/sprayer vehicle of FIG. 5.

FIG. 7 is a zoomed in, cross-sectional view of the spreader system of the spreader/sprayer vehicle of FIG. 5.

FIG. 8 is a rear view of the spreader/sprayer vehicle of FIG. 1.

FIG. 9 is a rear perspective view of a spreader/sprayer vehicle.

FIG. 10 is a side view of the spreader/sprayer vehicle of FIG. 1.

FIG. 11 is a top view of the spreader/sprayer vehicle of FIG. 1.

FIG. 12 is a bottom view of the spreader/sprayer vehicle of FIG. 1.

FIG. 13 is a perspective view of a powertrain system of a spreader/sprayer vehicle.

FIG. 14 is a front view of the powertrain system of FIG. 13.

FIG. 15 is a rear view of the powertrain system of FIG. 13.

FIG. 16 is a side view of the powertrain system of FIG. 13.

FIG. 17 is a top view of the powertrain system of FIG. 13.

FIG. 18 is a bottom view of the powertrain system of FIG. 13.

FIG. 19 is a perspective view of a steering system of a spreader/sprayer vehicle.

FIG. 20 is a front view of the steering system of FIG. 19.

FIG. 21 is a rear view of the steering system of FIG. 19.

FIG. 22 is a bottom view of the steering system of FIG. 19.

FIG. 23 is a side view of a hydraulic system of a spreader/sprayer vehicle.

FIG. 24 is a schematic view of a two-wheel steer vehicle executing a turn.

FIG. 25 is a schematic view of a spreader/sprayer vehicle executing a turn.

FIG. 26 is a perspective view of a hydraulic system of a spreader/sprayer vehicle.

FIG. 27 is a front perspective view of an embodiment of a spreader/sprayer vehicle.

FIG. 28 is a rear perspective view of the spreader/sprayer vehicle of FIG. 27.

FIG. 29 is a rear perspective view of another embodiment of a spreader/sprayer vehicle.

FIG. 30 is a zoomed in perspective view of the FIG. 29 spreader/sprayer vehicle.

FIG. 31 is a front perspective view of an embodiment of a vehicle.

FIG. 32 is a rear perspective view of the FIG. 31 vehicle.

FIG. 33 is a perspective view of an embodiment of a vehicle.

### DESCRIPTION OF THE SELECTED EXAMPLES

For the purpose of promoting an understanding of the principles of the disclosure, reference will now be made to the examples illustrated in the drawings and specific language will be used to describe the same. It will nevertheless be understood that no limitation of the scope of the disclosure is thereby intended. Any alterations and further modifications in the described examples, and any further applications of the principles of the disclosure as described herein are contemplated as would normally occur to one skilled in the art to which the disclosure relates. Exemplary examples of the disclosure are shown in greater detail, although it will be apparent to those skilled in the relevant art that some features that are not relevant to the present disclosure may not be shown for the sake of clarity.

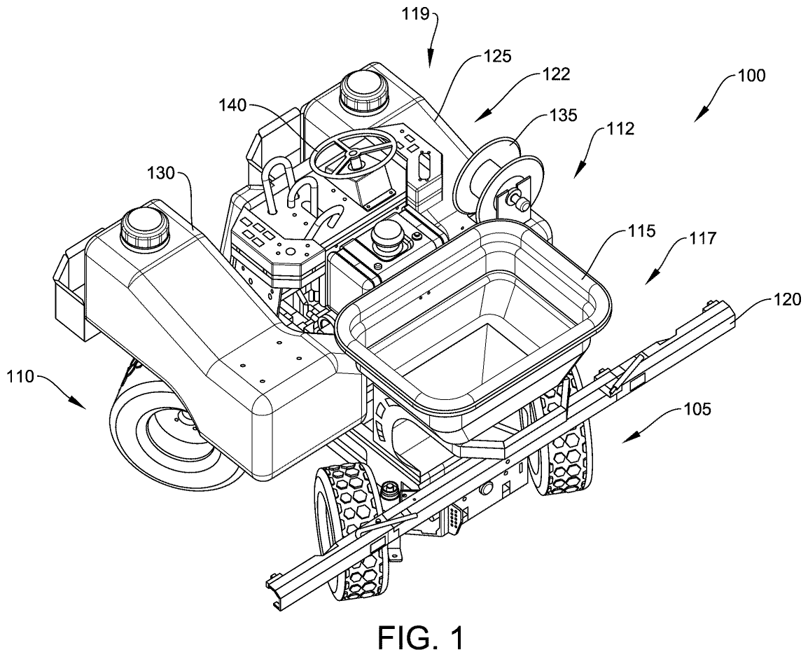

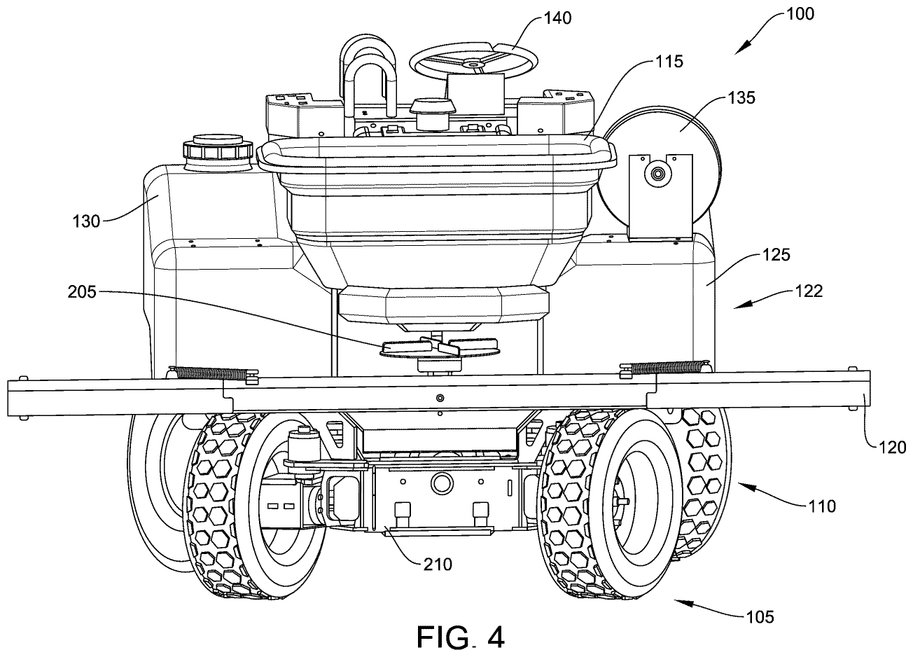

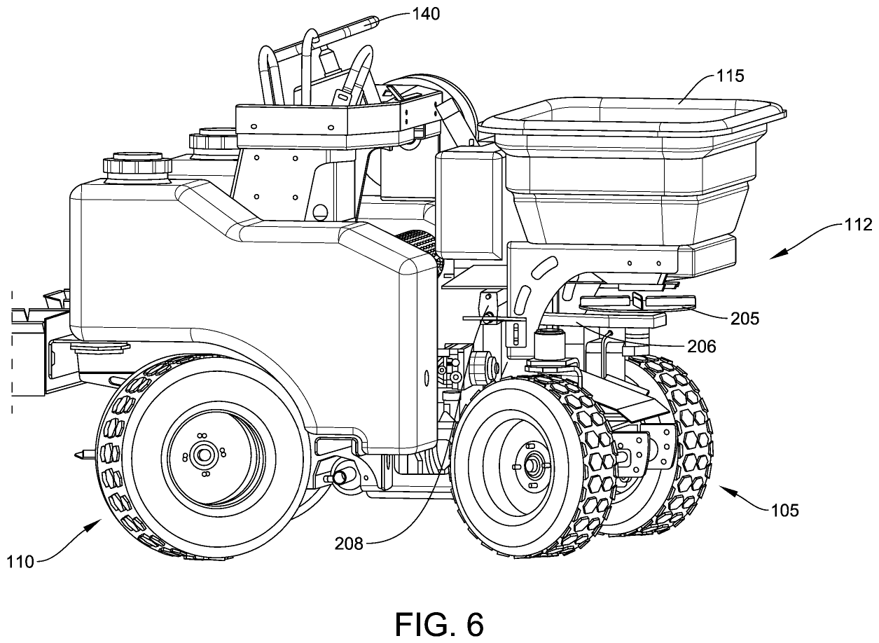

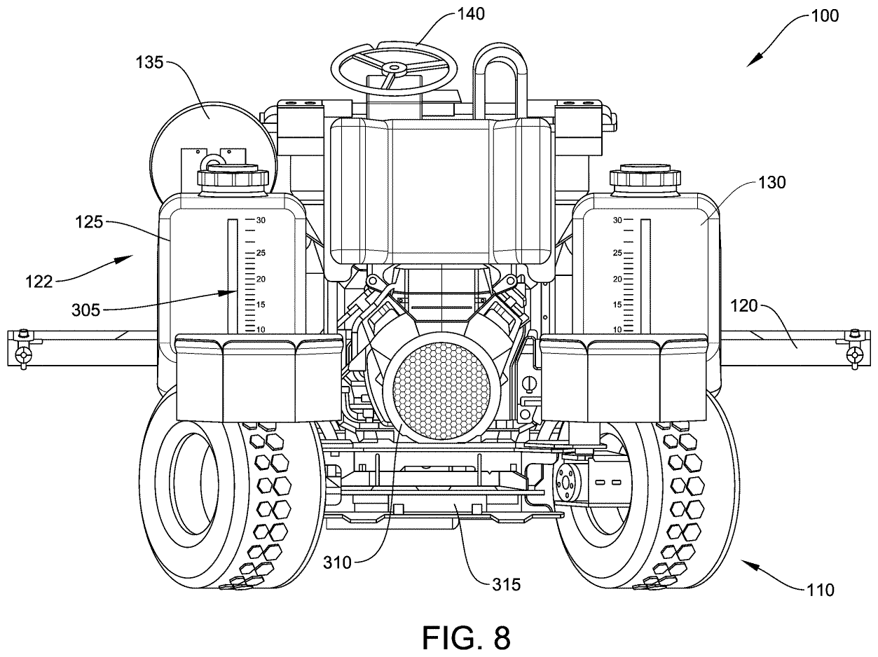

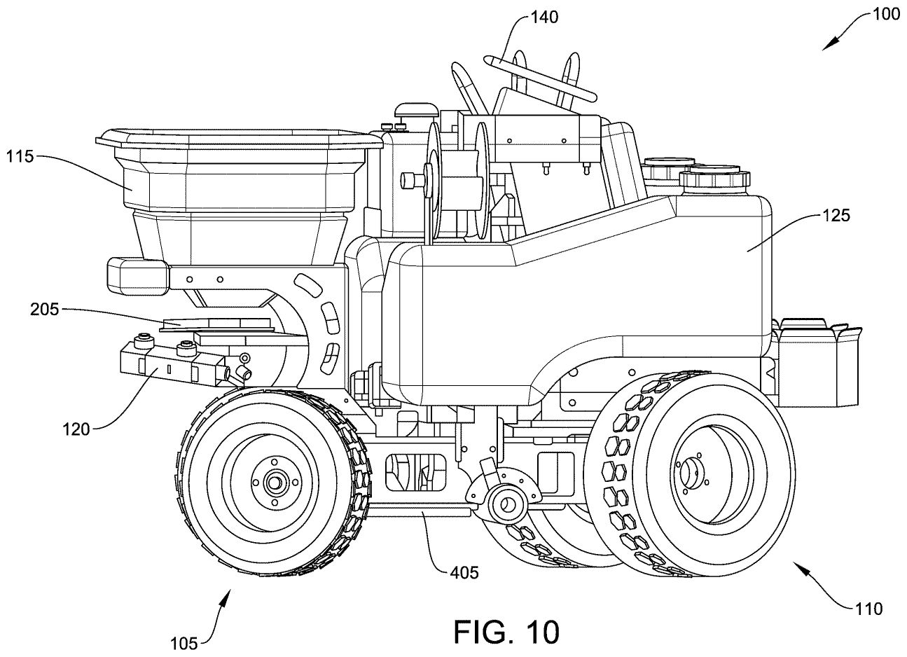

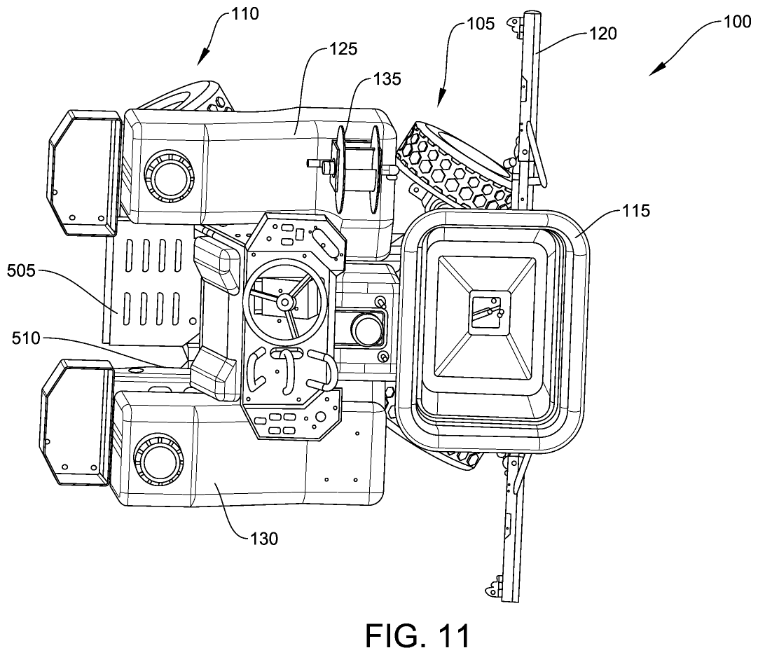

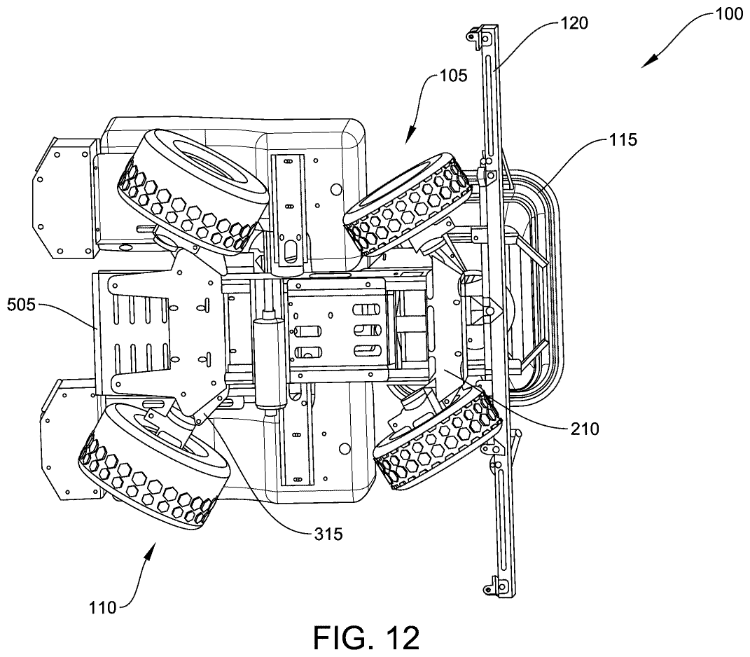

Illustrated in FIGS. 1-6 and 8-12 are various views of vehicles 100. For the purposes of explanation, the vehicles 100 are primarily illustrated in the form of spreader/sprayer vehicles. As should be appreciated, the vehicles 100 can be used for a variety of alternative or additional purposes, such as soil aeration, grading, leveling, and/or raking as some examples. The vehicles 100 are generally in the form of an all-wheel steer and all-wheel drive vehicle. However, in other examples, the vehicles 100 may be a two-wheel drive vehicle. For example, the vehicle 100 may be a front wheel and/or a rear wheel drive vehicle. Generally, the vehicle 100 includes a frame 405. The frame 405 generally includes a front axle 210. The vehicle may include a rear axle 315 located rearward of the front axle. Generally connected to the ends of the front axle 210 is a set of front wheels 105. The front wheels 105 are generally removably mounted to the ends of the front axle 210. Spaced rearward of the front set of wheels 105 and mounted to the ends of the rear axle 315 is a set of rear wheels 110. In one example, the front set of wheels 105 have a smaller diameter than the rear set of wheels 110. In another example, the front and rear sets of wheels may have the same diameter and/or the front set of wheels may have a larger diameter than the rear set of wheels. The front set of wheels 105 and the rear set of wheels 110 may have different sized wheel motors.

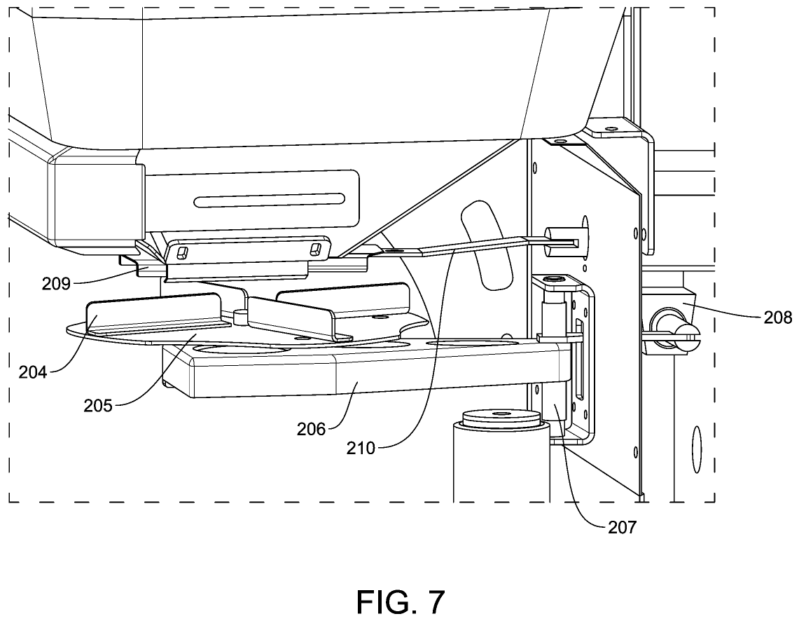

The vehicle 100 further includes a spreader/sprayer system 112. The spreader/sprayer system 112 generally includes a spreader assembly 117. The spreader assembly 117 includes a hopper 115 and a spreader 205 (e.g., impeller). Generally, material drops from the hopper 115 onto the spreader 205 for dispersion. As should be appreciated, the hopper 115 may be configurable to drop material at different rates (kg/min). For example, the hopper 115 may drop material at a greater rate (e.g., to dispense more product per area and/or over a greater area due to, for example, higher vehicle speed) and/or at a lower rate (e.g., to dispense less product per area and/or over a smaller area due to, for example, slower vehicle speeds). In one example, as shown in FIG. 7, the spreader/sprayer vehicle 100 includes a gate 209 actuatable relative to the outlet of the hopper to control the drop rate of the material. The gate 209 is attached to a lever arm 210 that is attached to and movable by a controller (not shown). The controller moves the lever arm 210 and the gate 209 relative to the outlet of the hopper 115 to control the flow of granular material from the hopper 115.

As stated, the controller may control the position of gate 209 relative to hopper 115 based, at least in part, on the speed of the vehicle 100. The controller may receive ground speed information in a number of suitable ways. For example, the vehicle 100 may be equipped with sensors, lasers, tachometers, speedometers, accelerometers, RADAR, and/or LIDAR, etc., to measure speed and/or acceleration of vehicle 100. In other embodiments, operator inputs may control the amount of material dispensed from the hopper 115 and spreader system 117. In yet other embodiments, the vehicle 100 may utilize a combination of control mechanisms to properly actuate gate 209 to spread a desired amount of material.

Similarly, the spreader 205 may operate at a user defined variable speed (e.g., angular velocity). In some embodiments, the speed of impeller 205 is a function of the ground speed of vehicle 100. Alternatively or additionally, the speed of the impeller 205 may be a function of the desired broadcast rate (kg/hectare) of product.

The spreader assembly 117 of vehicle 100 is configured to adjust the broadcast pattern of the material being dispensed from the spreader/impeller 205. The spreader assembly 117 is configured to horizontally translate the impeller 205 so that material dispersed from the outlet of the hopper 115 and/or gate 209 can be positioned on the spreader/impeller 205 at various locations. As the location on which the material lands on the impeller impacts where (i.e., what direction and how far) the material is broadcast, horizontal translation of the impeller 205 can change the broadcast pattern of the material exiting the spreader assembly 117 (e.g., broadcast more rightward or leftward).

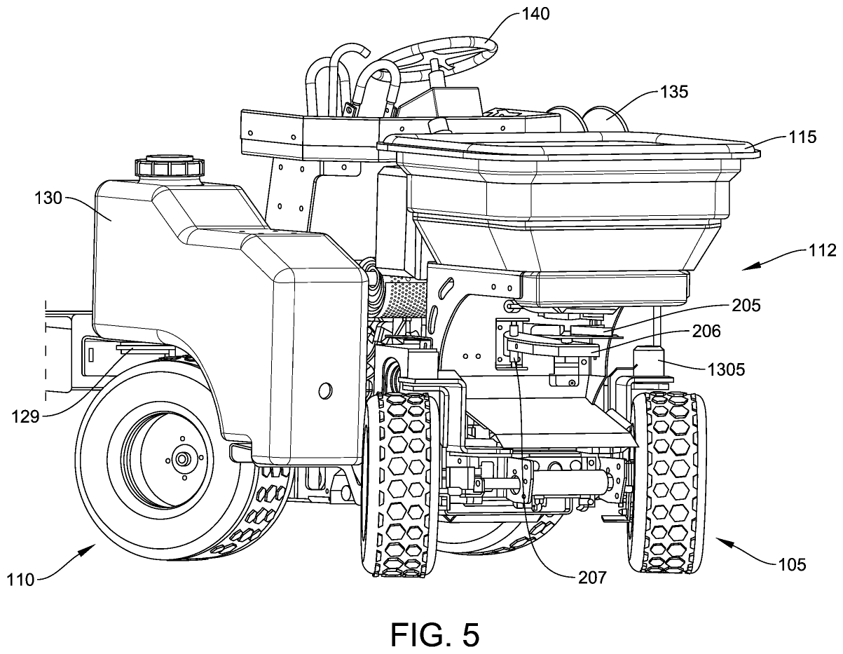

As illustrated in FIGS. 5-7, the spreader assembly 117 includes an impeller 205 attached to a support arm 206, a pivot point 207, and a controller 208. The support arm 206 is configured to house electrical connections and other components necessary for operation of impeller 205. Further, the support arm 206 is securely connected to pivot point 207. Similarly, the controller 208 is securely connected to pivot point 207. The controller 208 is configured to actuate in response to user inputs. Actuation of controller 208 causes rotational movement of pivot point 207 around its vertical axis, which causes horizontal translation of support arm 206 and impeller 205. In this way, user input can change where material being dispensed from the hopper 115 drops onto the impeller 205 and, thus, alter the broadcast pattern of the material. This allows an operator to control spreading material where the user desires and avoiding spreading material where they do not without changing the direction and/or speed of the vehicle or employing a deflecting plate to block broadcast of material in a particular direction.

The spreader system 117 further includes impeller vanes 204 optionally configurable at various angles relative to the center of impeller 205. Specifically, each vane 204 is attached at its two ends to the impeller 205 at two locations, one centrally and one toward the periphery of impeller 205. The vanes 204 are attached to the impeller 205 via fasteners at both the central and periphery locations. However, for each vane 204, there are a plurality of fastening locations at the periphery of impeller 205. Attachment of the vane 204 at one of the periphery attachment locations alters the angle of the vane 204 relative to the center of impeller 205, compared to attachment of the vane 204 at another of the periphery attachment locations. Thus, an operator can selectively alter the angle of vanes 204 to produce a desired broadcast pattern/spread.

The spreader/sprayer system 112 further includes a sprayer assembly 119. The sprayer assembly 119 includes one or more tanks 122, a boom sprayer 120, and/or a hose on a hose reel 135. The hose is preferably connected to a sprayer wand (not shown). The one or more tanks 122 may include a first tank 125 and a second tank 130. In some examples, the tanks may include a fill gauge 305. The fill gauge 305 may be used to indicate the amount of liquid within the tank. Generally, the tanks are in fluid communication with the boom sprayer 120. As should be appreciated, the one or more tanks 122 may include the same liquid and/or different liquids. Generally, the boom sprayer 120 is located forward of the front set of wheels 105. The boom sprayer 120, however, may be located between the front and rear wheels or even rearward of the rear wheels 110. The hose and hose reel 135 are generally in fluid communication with the one or more tanks 122. The hose and hose reel 135 enable a user to apply a more concentrated stream of liquid, if desired.

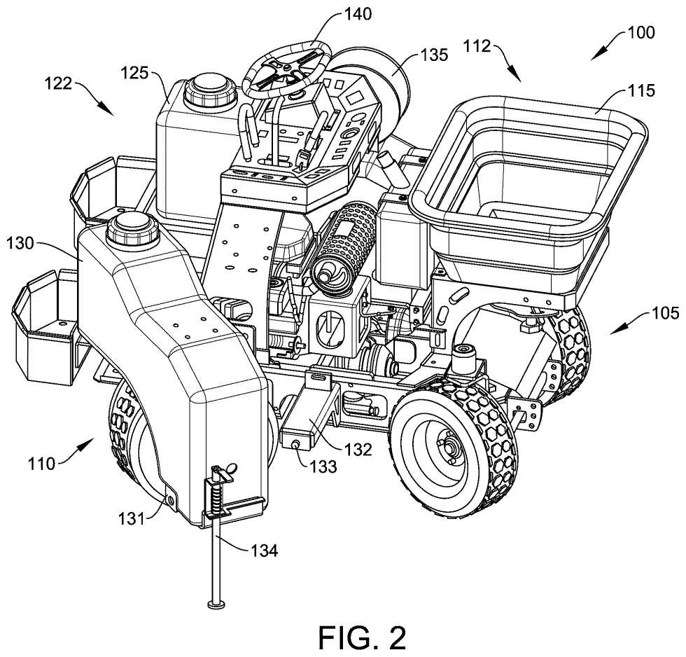

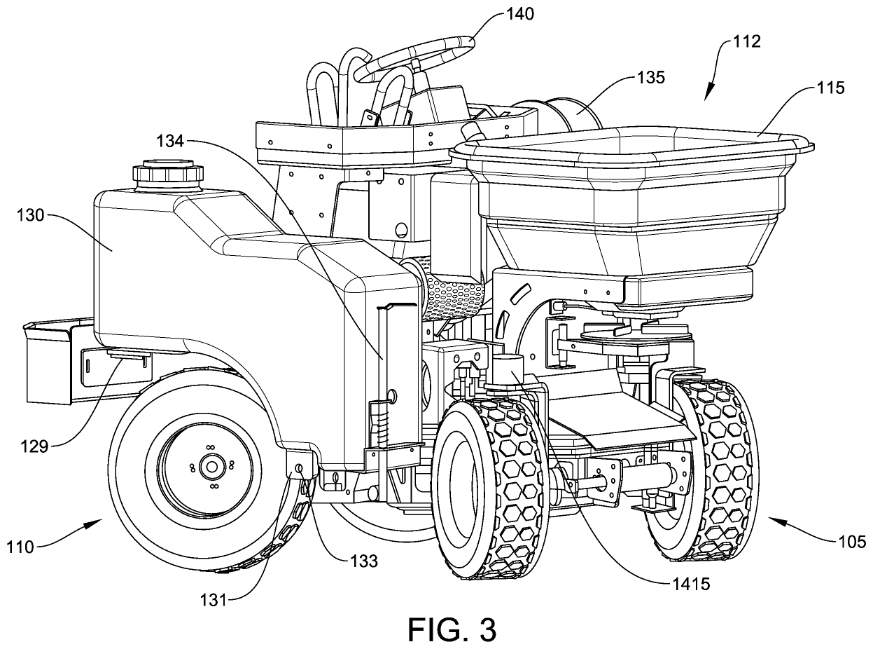

In some embodiments of a spreader/sprayer vehicle 100, the first tank 125 and/or second tank 130 are optionally configurable from a first position to a second position to allow for easy access to internal components of vehicle 100 during maintenance. FIG. 2 illustrates tank 130 in a second position, whereas FIG. 3 depicts the tank 130 in a first position. In the depicted embodiment, the tank assembly includes bearing 129, the tank 130, locking member 131, support arm 132, lock 133, and support leg 134. In the first position, tank 130 is supported by support arm 132 and selectively locked to the support arm 132 by locking member 131 and lock 133. In the depicted embodiment, a pin is inserted through lock 133 to prevent movement of the tank 130 by engaging locking mechanism 131. However, other locking mechanisms may be used. The tank 130 is optionally rotatable about bearing 129. In the second configuration, the support leg 134 is optionally extendable to support weight of tank 130.

The front set of wheels 105 and the rear set of wheels 110 are generally steerable via a steering wheel 140. The steering wheel 140 may be a round steering wheel. In another embodiment, the steering wheel 140 may be a yoke, lever(s), slider(s) and/or knob(s).

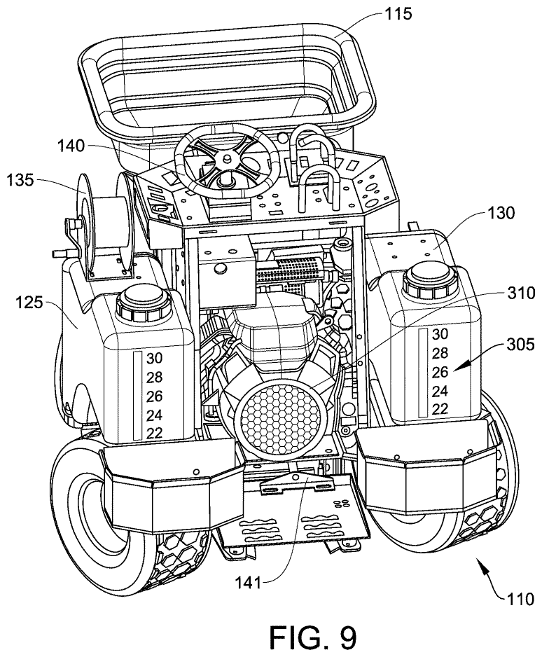

During operation of the vehicle 100 the user generally stands on a platform 505. Located adjacent the platform 505 is a padded surface 510. The padded surface 510 works in combination with the platform 505 to allow a user to comfortably operate the vehicle 100 by way of the user standing on the platform and leaning on the padded surface. In some examples, the vehicle 100 includes foot control 141, as shown in FIG. 9. The foot control 141 may be configured to provide independent and/or redundant control of vehicle 100. For example, foot control 141 may control the speed of vehicle 100 in either forward or reverse directions, or both. Foot control 141 allows an operator to control forward and/or reverse speed by foot control 141, steer vehicle 100 by steering wheel 140 with one hand, and with another hand articulate the spreader and/or sprayer system (e.g., use a handheld sprayer wand of the sprayer system 119 and/or articulate the spreader). The vehicle 100 may include a seat, chair, and/or saddle for a user.

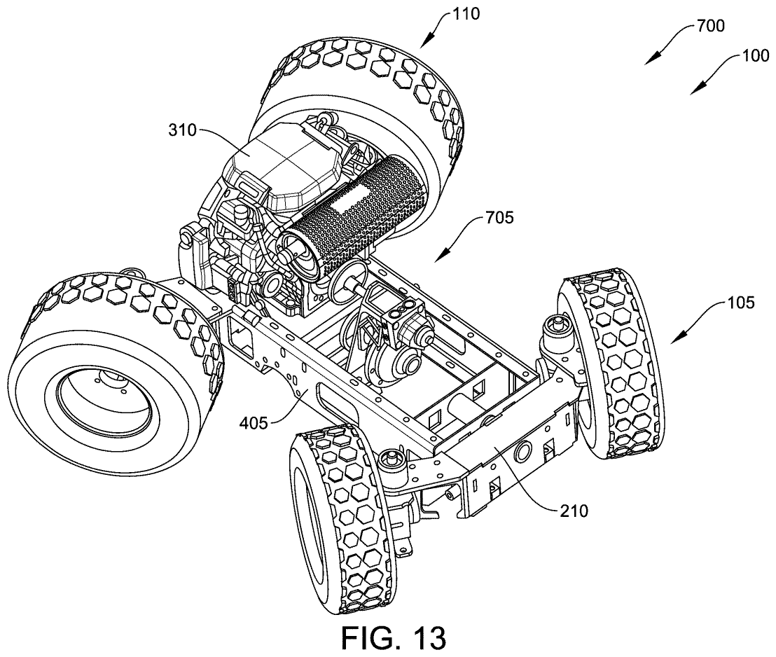

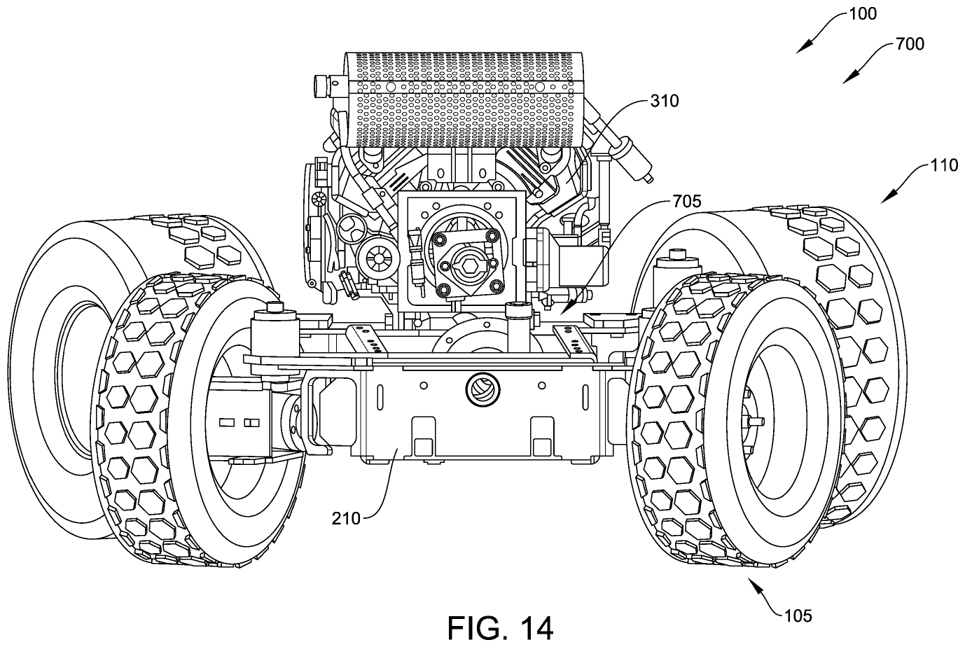

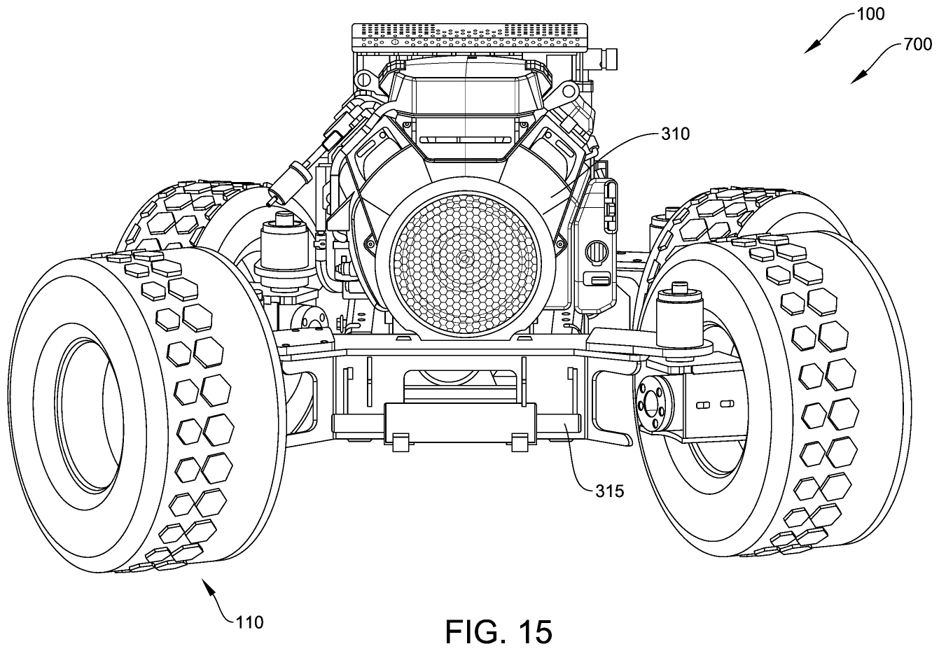

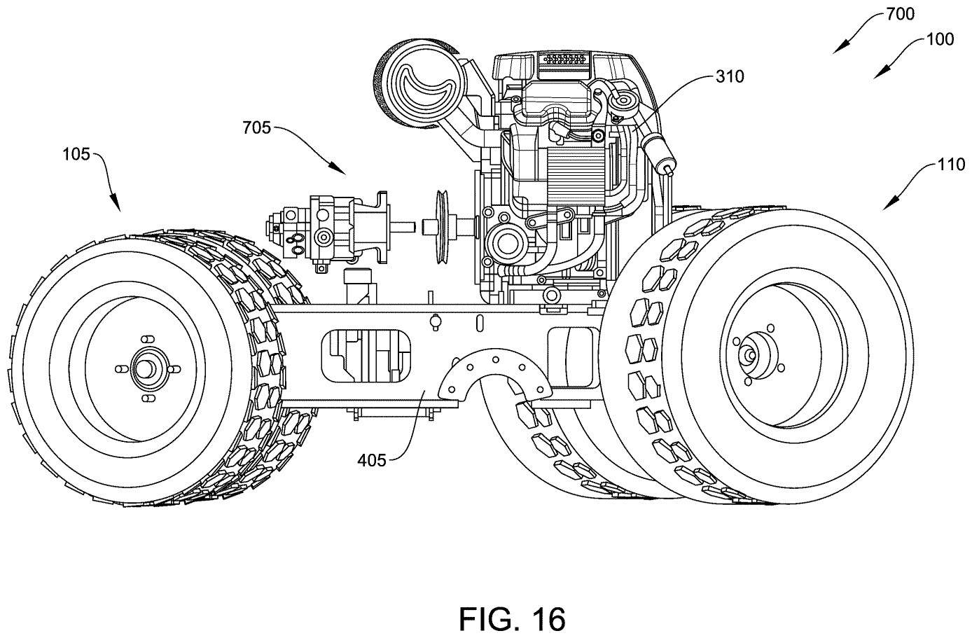

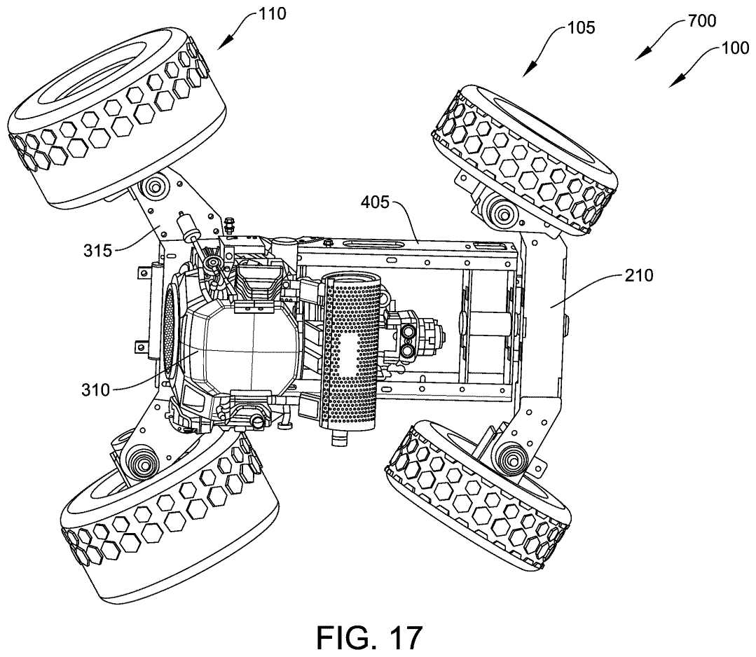

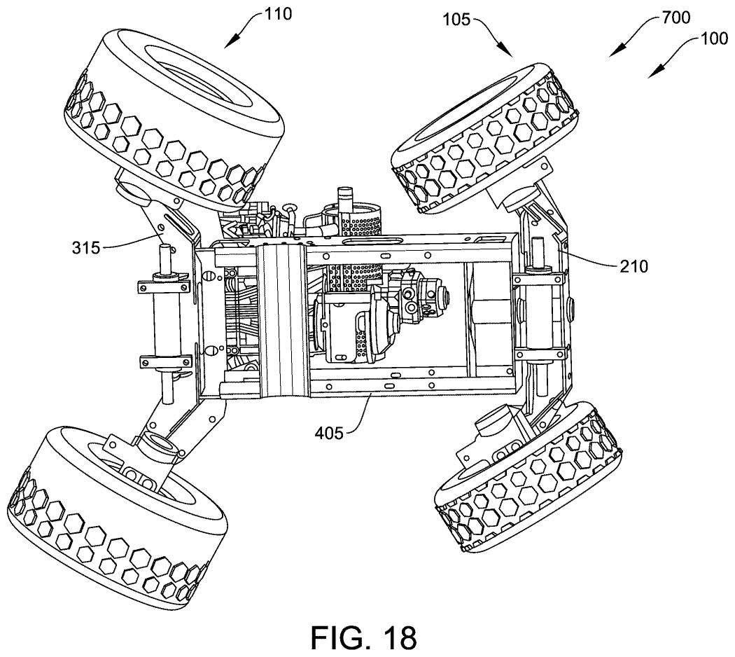

FIGS. 13-18 illustrate multiple views of a powertrain system 700 of the vehicle 100. Generally, the powertrain system 700 includes a motor 310 and a hydraulic system 705. The motor 310 is generally an internal combustion engine. However, in other examples, the motor 310 may be an electric motor, a diesel engine, a hybrid motor, a hydraulic motor, and/or a pneumatic motor. The motor 310 is configured to supply rotational power to the hydraulic system 705. The hydraulic system 705 works to articulate the front and rear set of wheels as well as to drive each of the front and rear set of wheels. The hydraulic system 705 receives power from the motor 310 to pressurize one or more hydraulic lines (not shown for ease of illustration) to power the wheels. In other examples, the hydraulic system 705 may be replaced with a pneumatic system.

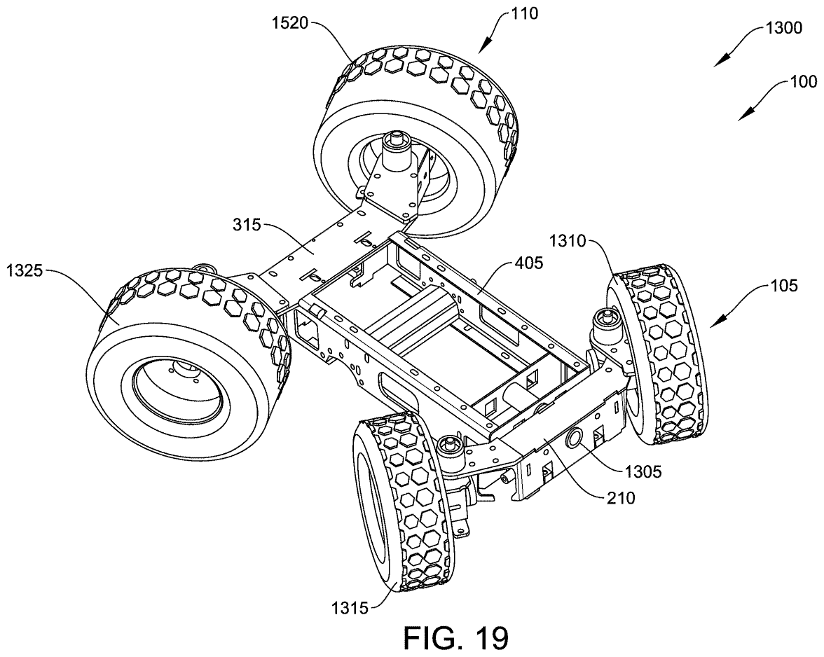

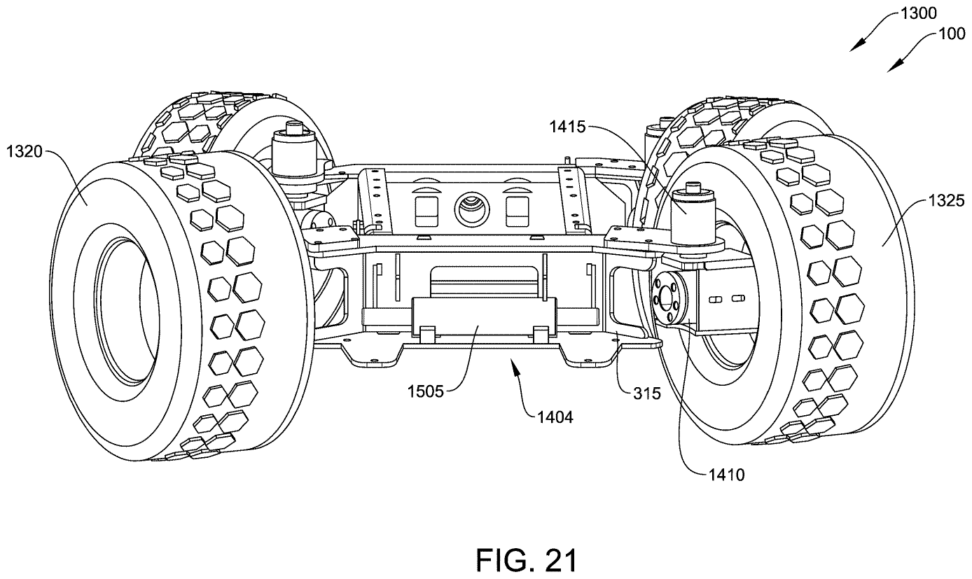

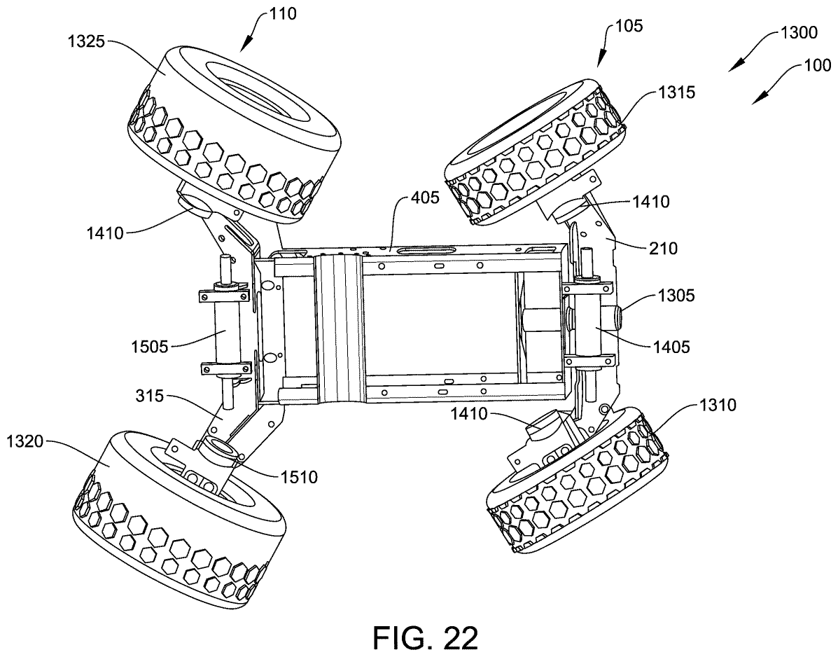

Shown in FIGS. 19-22 are views of a steering system 1300 of the vehicle 100. The steering system 1300 generally includes the set of front wheels 105 and the set of rear wheels 110. The set of front wheels 105 generally includes a front wheel 1310 and a second wheel 1315. The set of rear wheels 110 generally includes a third wheel 1320 and a fourth wheel 1325. As should be appreciated, each of the wheels are driven and steerable. In other examples, the vehicle 100 may include more or fewer wheels. For example, the vehicle 100 may include three and/or six wheels. Generally, the first wheel 1310 and the second wheel 1315 are located on opposing ends of the front axle 210. Located between the first wheel 1310 and the second wheel 1315 is a central kingpin 1305. The kingpin 1305 serves as a pivot point for the front axle 210. For example, to turn left a user rotates the steering wheel 140 to the left. As a result, the front axle 210 rotates about the kingpin 1305 to effectuate the turn. In some examples, the vehicle 100 may not include a central kingpin 1305. In other examples, both front and rear axles may articulate relative to the frame.

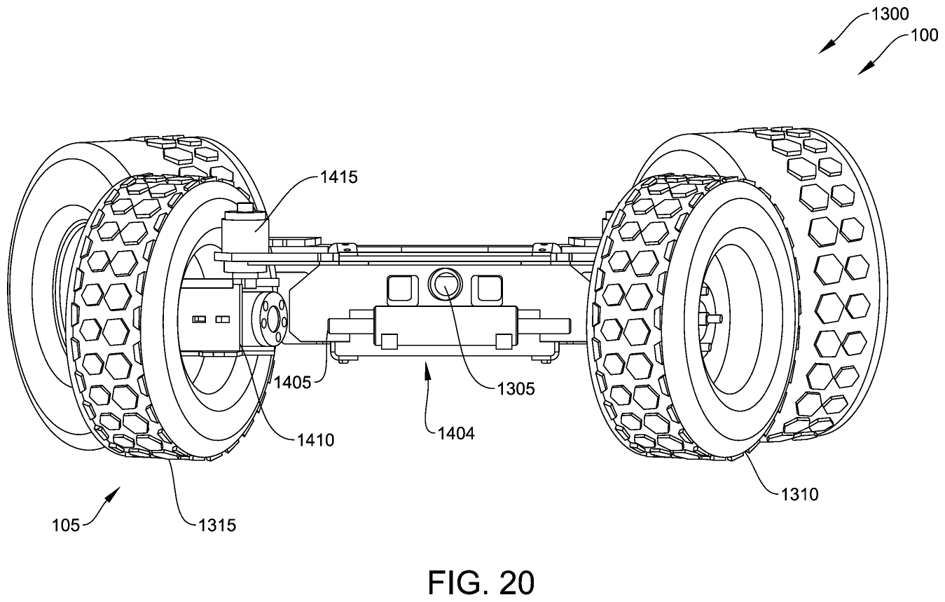

Located adjacent each of the wheels is an outer joint kingpin 1415. The outer joint kingpin 1415 serves as a pivot point for each individual wheel. As should be appreciated, locating a pivot point nearer the wheel can enable the vehicle to make sharper turns. The outer joint kingpin 1415 works in combination with a hydraulic cylinder 1404. For example, the hydraulic cylinder 1404 applies pressure to the wheel, which in turn rotates about an axis formed by the outer joint kingpin 1415. In some embodiments, shown in FIG. 3, the outer joint kingpin 1415 is located above front wheels 105. Advantageously, this configuration allows for additional room in between front wheels 105 for additional components or to reduce the overall width of vehicle 100 to less than or equal to 915 mm wide. In other embodiments, illustrated in FIG. 20, the outer joint kingpin 1415 is located adjacent to the front wheels 105. Similarly, the outer joint kingpins 1415 located near rear wheels 110 may either be located adjacent to or above rear wheels 110.

In an example embodiment, the vehicle 100 is outfitted with an all-wheel steer configuration. To effectuate this, the vehicle 100 includes a first hydraulic cylinder 1405 and a second hydraulic cylinder 1505. The hydraulic cylinders are fluidly connected to one another such that when the front set of wheels turn in a first direction the rear set of wheels turns in a second, opposite direction. In one embodiment, the hydraulic cylinders may be rephasing cylinders. Rephasing cylinders may be used to maintain the front and rear set of wheels at the same turning angle. In other embodiments, the vehicle 100 may utilize Ackerman steering, front wheel steering, and/or rear wheel steering. In yet another embodiment, the vehicle 100 may include a lever and/or switch to lock the rear set of wheels 110 into position. For example, the user may place the rear set of wheels into the desired position and actuate the lever to lock the rear set of wheels. This method of disabling the all-wheel steer and converting the vehicle 100 to front wheel steer is advantageous for higher speed driving.

Located adjacent each wheel is a hydraulic motor 1410. The hydraulic motor 1410 is generally connected to the hydraulic system 705 via one or more hoses (not shown for ease of illustration). Each hydraulic motor 1410 works to power a wheel. Hydraulic motors for different wheels and/or wheels of different size may turn at different speeds. For example, a hydraulic motor 1410 for a smaller wheel preferably rotates the wheel at a greater angular velocity than a larger wheel of the vehicle. Similarly, a hydraulic motor for an outer wheel during a turn is preferably rotated at a greater angular velocity than an inner wheel.

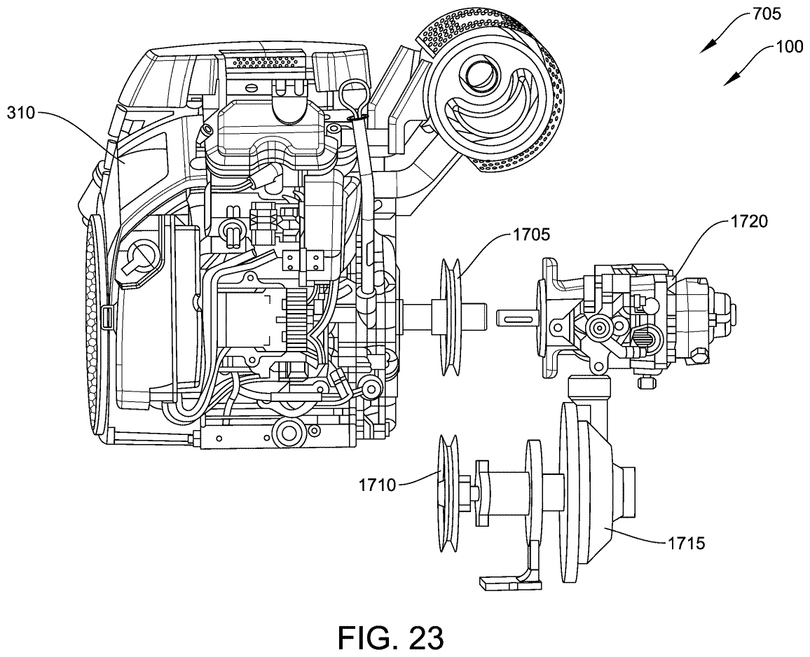

Turning to FIG. 23, the hydraulic system 705 is shown. The hydraulic system 705 generally includes the motor 310, a pump 1715, and a valve 1720. Generally, the motor provides rotational power to a first pully 1705. The first pully 1705 is generally connected to a second pully 1710 via a belt (not shown for ease of illustration). Rotation of the second pully 1710 generates pressure within the pump 1715. Pressurized fluid flows from the pump 1715 into the value 1720. The valve 1720 controls the location and flow of the fluid. For example, the valve may send pressurized fluid to the hydraulic cylinder and/or one or more of the hydraulic motors. Generally, the value 1720 may be connected to the hydraulic cylinders and/or hydraulic motors via one or more hoses (not shown for ease of illustration). In other embodiments, the hydraulic system 705 may include two or more valves. In other examples, the hydraulic system 705 may be replaced with a pneumatic system.

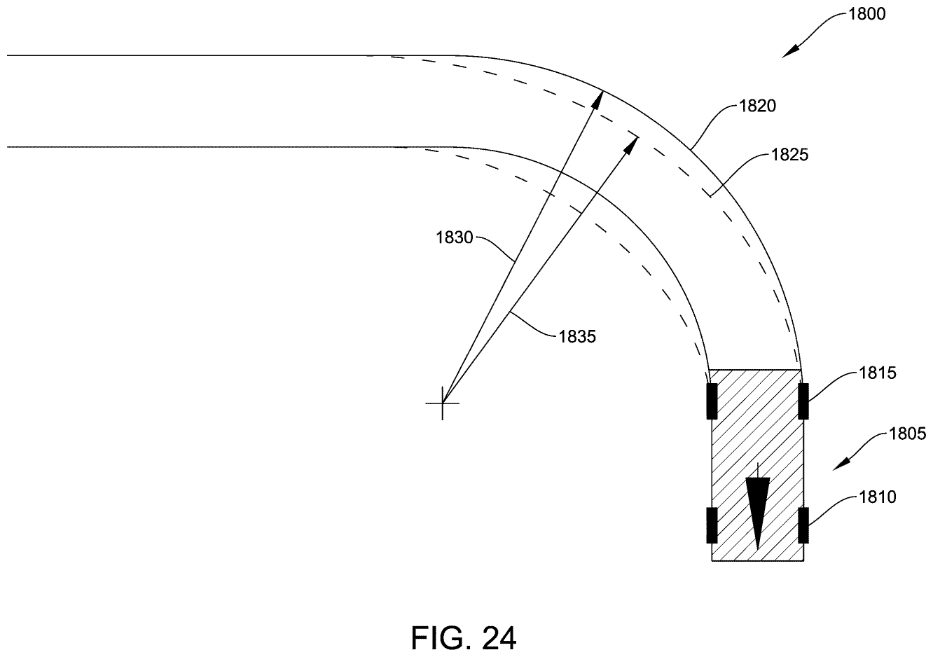

Looking to FIG. 24, an example of a two-wheel steer vehicle 1805 is shown executing a turn 1800. The two-wheel steer vehicle 1805 generally includes a set of steered front wheels 1810 and a set of unsteered rear wheels 1815. During a turn, the set of front wheels follow a front wheel path 1820 and the set of rear wheels follow a rear wheel path 1825, which is different from the front wheel path. For example, the front wheel path may have a radius of curvature shown by 1830 and the rear wheel path may have radius of curvature shown by 1835. As can be seen, the rear wheel path radius of curvature is a shorter than the front wheel path radius of curvature.

Applicant has observed that with a two-wheel steer vehicle, the location of the sprayer on the vehicle will affect sprayer coverage. For example, a sprayer located on a front of the vehicle will spray a different area than a sprayer located on a rear of the vehicle. Additionally, because the front of the vehicle and the rear of the vehicle follow curves having different radii of curvature, one end of the vehicle will travel along a greater distance and, therefore, area than the other end of the vehicle. Accordingly, for a given vehicle speed, spray pattern and sprayer setting (e.g., liters per minute), more product (e.g., pesticide) may be dispersed per unit area if the sprayer is positioned at one end of the two-wheel steer vehicle than if at the other end.

Applicant has also observed that when the sprayer is positioned nearer the steered wheels, the effective width of a spray pattern from a boom sprayer is less than when the sprayer is positioned nearer the non-steered wheels. Accordingly, the location of boom sprayer placement for two-wheel steered vehicles may change the spray pattern and result in the over-application or under-application of product to areas of the surface. This can occur, for example, due to translation of the boom sprayer across the surface in a direction that is not orthogonal to a longitudinal axis defined by the boom sprayer. As will be appreciated, translating the boom sprayer across a surface with the longitudinal axis of the boom sprayer non-orthogonal to the direction of travel can result in a second portion (e.g., length) of a spray pattern from the boom sprayer overlapping an area of ground sprayed by a first portion (e.g., length) of the spray pattern of the boom sprayer. This “double coverage” is not preferable as it can result in an over-application of product to the surface. Furthermore, such overlapping can reduce the effective width of the spray pattern and, therefore, result in the under-application of product to areas outside of the effective width of the spray pattern and/or require additional passes of the boom sprayer over the surface to cover such areas.

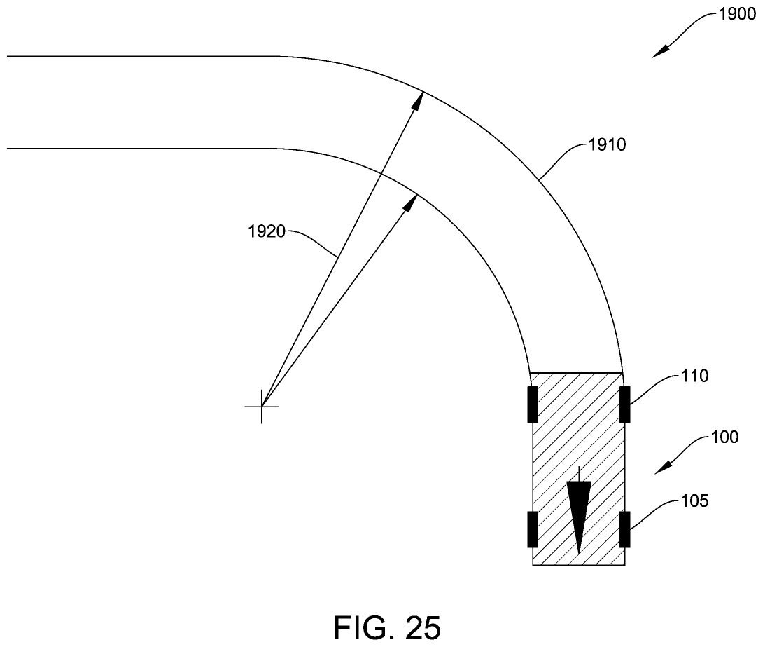

To contrast this, we turn to FIG. 25, which shows an example of the all-wheel steer vehicle 100 executing a turn 1900. During the turn, the set of front wheels 100 and the set of rear wheels 110 follow the same wheel path 1900. For example, the radius of curvature 1920 for the path of the front and rear wheels is the same. Put differently, the rear wheels follow in the track of the front wheels.

As should be appreciated, the method discussed in FIG. 25 results in multiple benefits. For example, with an all-wheel steer vehicle, the sprayer (e.g., a boom sprayer) may achieve a given effective spray pattern width at more than one location on the vehicle. For example, a spray pattern from a sprayer (e.g., boom sprayer) placed on the rear of the vehicle can follow the same path as the spray pattern from the same sprayer if placed on the front of the vehicle, so the spray coverage area and concentration can remain the same regardless of sprayer location. Further, there can be less “double coverage” during a turn than some two-wheel steered vehicles due to a fan spray pattern (e.g., from a boom sprayer) having a velocity vector nearer to a direction orthogonal to the longitudinal axis of the fan spray pattern.

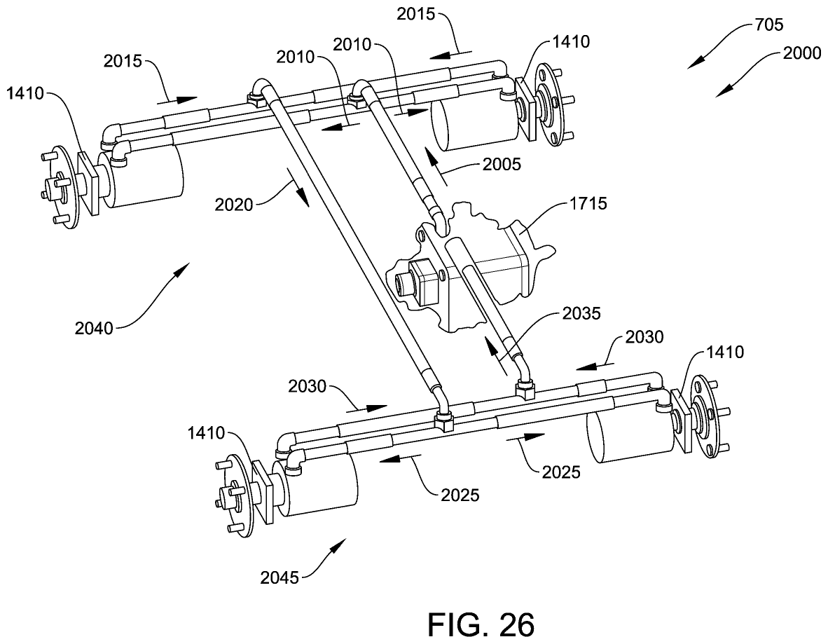

FIG. 26 shows another example of the hydraulic system 705. The hydraulic system 705 includes a hydraulic circuit 2000. The hydraulic circuit 2000 begins at the hydraulic pump 1715. The hydraulic pump 1715 is connected in series with a first set 2040 of hydraulic motors 1410. The hydraulic motors 1410 are connected in parallel to one another. The first set 2040 of hydraulic motors are then connected in series with a second set 2045 of hydraulic motors 1410. Similar to the first set, the second set 2045 of hydraulic motors 1040 are connected together in parallel. From the second set 2045 of hydraulic motors 1410, the hydraulic pump 1715 is connected in series. The parallel connection between the hydraulic motors 1410 enables hydraulic fluid transfer to act as a differential for turning. For example, more hydraulic fluid may flow to a hydraulic motor needing a greater amount of fluid than the other. Additionally, the series connection of the first set 2040 and second set 2045 enables at least one hydraulic motor 1410 from each of the first set 2040 and the second set 2045 to have hydraulic flow. In another example, the hydraulic system 705 may include two hydraulic pumps 1715. For example, a first hydraulic pump connected to the first set 2040 of hydraulic motors 1410 and a second hydraulic pump connected to the second set 2045 of hydraulic motors 1410. As should be appreciated, using two separate hydraulic pumps enables the first set 2040 and second set 2045 of the hydraulic motors 1410 to be independent systems.

An example of hydraulic fluid flow will now be described with respect to FIG. 26. Beginning at the pump 1715, fluid flows as indicated by arrow 2005 into the first set 2040 of hydraulic motors 1410 as shown by arrows 2010. Fluid is then able to flow from the hydraulic motors as shown by arrows 2015. Fluid flows from the first set 2040 to the second set 2045 of hydraulic motors 1410 as shown by arrow 2020 and into the hydraulic motors as shown by arrows 2025. Hydraulic fluid may then transfer from the hydraulic motors as shown by arrows 2030. From the second set 2045 of hydraulic motors 1410 fluid flows back into the pump 1715 as shown by arrow 2035.

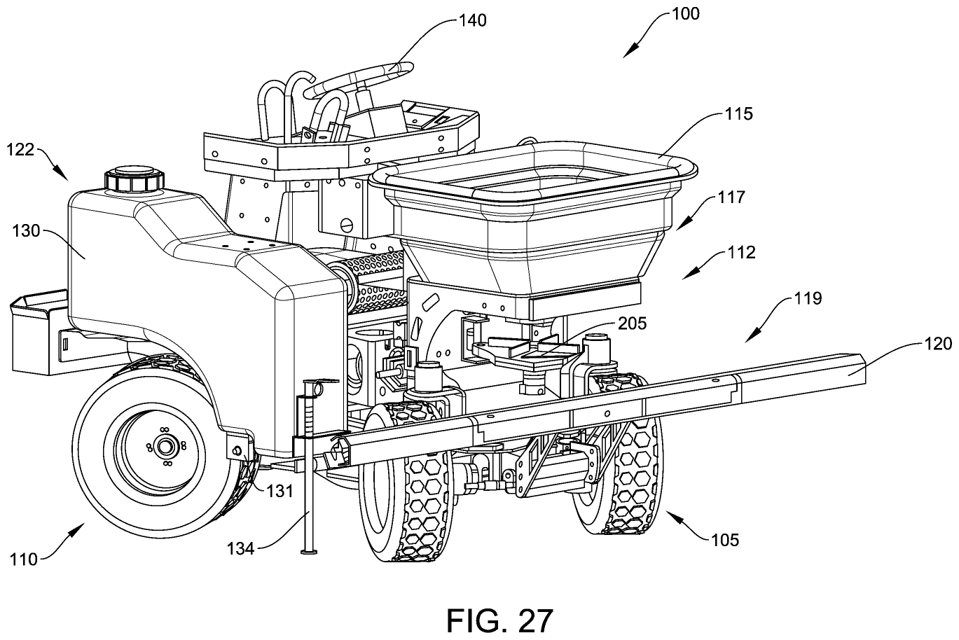

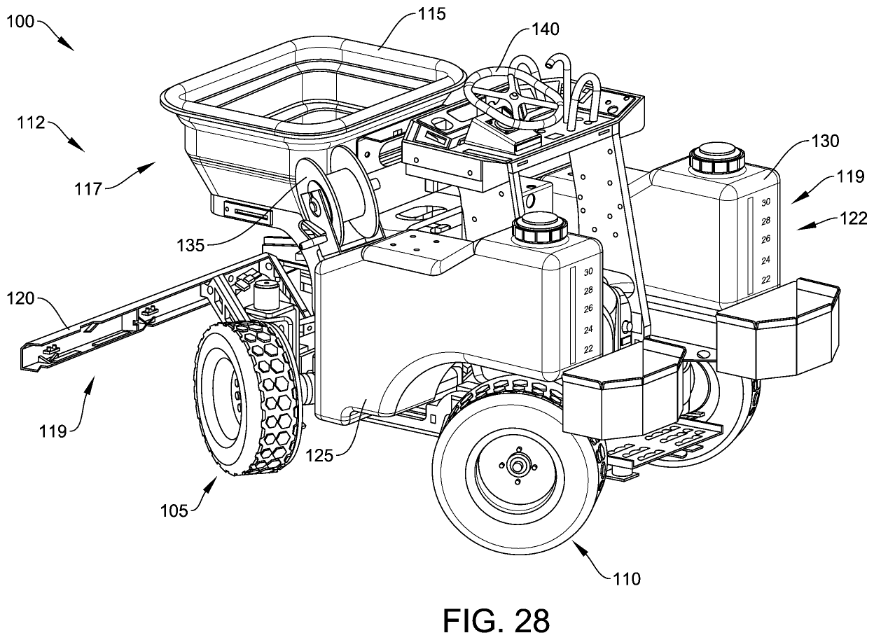

FIGS. 27 and 28 depict a front perspective view and a rear perspective view of a spreader/sprayer vehicle, respectively. In this embodiment, the sprayer assembly 119 includes a boom sprayer 120 in fluid connection with one or more of the tanks 122. As should be appreciated, the one or more tanks 122 may include the same liquid and/or different liquids. Generally, the boom sprayer 120 is located forward of the front set of wheels 105. The boom sprayer 120, however, may be located between the front and rear wheels or even rearward of the rear wheels 110.

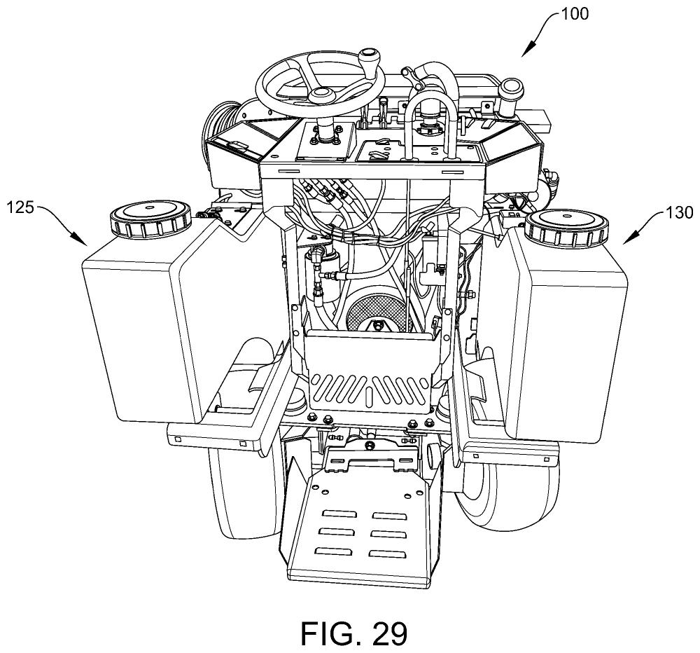

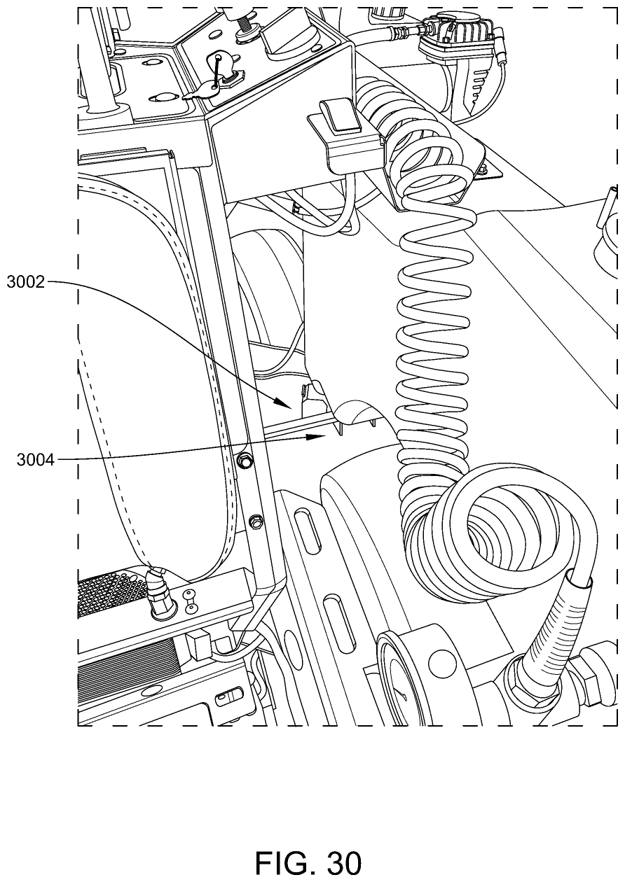

Referring to FIGS. 29 and 30, in some embodiments of a spreader/sprayer vehicle 100, the first tank 125 and/or second tank 130 are optionally configurable to slide away from the vehicle 100. As noted, the first tank and/or second tank are optionally configurable from a first position to a second position to allow for easy access to internal components of the vehicle 100 during maintenance. Instead of or in addition to pivoting out from vehicle 100, such as shown in the FIG. 2 example, the first tank and/or the second tank are configured to slide laterally away from the vehicle 100 to provide access to internal components (e.g., vehicle motor and/or hydraulic pumps, valves, and or lines). In the illustrated embodiment, the vehicle 100 includes a track 3002 (e.g., a bar or rail) that supports the tank. The tank may include a bracket 3004 that attaches the tank to the track while allowing the tank to slide along the track and/or allowing the track to slide outwardly away from the vehicle with the tank. The vehicle 100 may further include a locking member, lock, support arm, and/or support leg such as shown in FIG. 2, for securing and/or support the tank(s).

In a preferred sliding tank embodiment (e.g., FIGS. 29-30), the first tank 125 and/or second tank 130 mount to a track 3002 that comprises linear rails or rollers integrated into the chassis frame rearward of the rear wheels. A bracket 3004 on the tank underside engages the track and enables lateral extension for inspection, cleaning, or replacement. The lateral extension may be 0.5 to 1.5 meters. Locking mechanisms (e.g., spring-loaded pins, electromagnetic locks) may secure the tank during operation, and hydraulic assists (powered by hydraulic system 705) or manual levers may enable smooth sliding. Support legs 134 may deploy automatically upon extension and may bear up to 500 kg.

The sliding tank embodiment includes variations such as a single-tank configuration, dual independent tanks with synchronized rails for balance, and fuel/water-specific tanks with quick-connect fittings to sprayer lines. All of the above may be used with a narrow vehicle (<915 mm width).

Integration of the sliding tank with the chassis promotes stability. For example, the rails may be reinforced with frame cross-members and tested for slopes up to 20°.

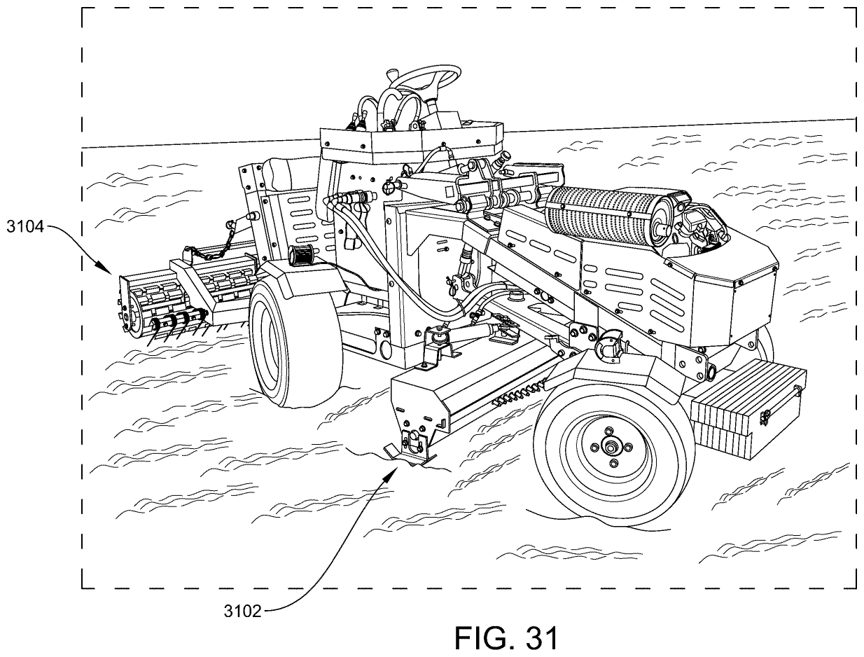

FIGS. 31, 32, and 33 depict embodiments with diverse ground-engaging attachments (“rakes” and “drags”) via modular mounting systems. The vehicle 100 includes a first attachment 3102 (e.g., a Harley rake positioned between the wheels), a second attachment 3104 (e.g., a tine/roller compactor positioned rearward), and/or an S-tine attachment 3302. Harley rakes feature a toothed drum that is hydraulically driven (e.g., rotated) from system 705 for leveling and/or regrading turf or gravel. Tine/roller compactors can aerate and compact soil, with tines optionally adjustable to 6-12″ in length and rollers optionally of 12-36″ diameter. S-tines can loosen compacted soil with optionally 3-8″ penetration. Modular quick-release couplers (e.g., ISO-standard pins or skid plates) enable faster swapping. Adjustability can includes depth and angle controls that are linked to steering and speed controls and may include presets.

Lifting mechanisms can comprise hydraulic arm assemblies (3202, 3306) with pivoting arms, single or double-acting cylinders, optional load sensors for auto-balancing, and optional mechanical locks (pin-drop type) that prevent unintended drops. The arms raise attachments (e.g., between 0.2 m and 1 m) for transport, storage, or clearance.

Examples of use include a Harley rake, an S-tine, and a compactor for even surfacing in equine arenas. The vehicle supports multi-task functionality, such as sequencing rake-aerate-compact in one pass.

The engine or motor 310 is positioned over the forward wheels 105 to optimize the center-of-gravity (CoG) between the forward and rearward wheels. This placement may incorporate reinforced mounting brackets and vibration dampeners (e.g., rubber isolators). The rationale for this configuration helps promote constant ground force across the forward and rearward wheels and may help avoid front wheel lift during acceleration or turns which is a common issue in rear-heavy skid-steers. The benefits include improved traction on turf and hillsides. Variations allow adjustability for different loads (e.g., forward and/or rear ballast) or vehicle sizes (e.g., narrower versus wide wheelbase).

The vehicle customizes for specific industries, such as equine arenas using a Harley rake, compactor, and sprayer for surfacing and hydration, or golf courses using an aerator and seeder options for turf health. Interchangeable modules attach via couplers, and controls may include user-selectable presets (e.g., depth/speed profiles). The design is scalable, with attachments such as small-site tines versus large-arena rollers.

Certain embodiments combine the spreader and sprayer with attachments, for example, seeding after raking. All such customizations can be supported by the existing frame, hydraulics, and FIGS. 31-33.

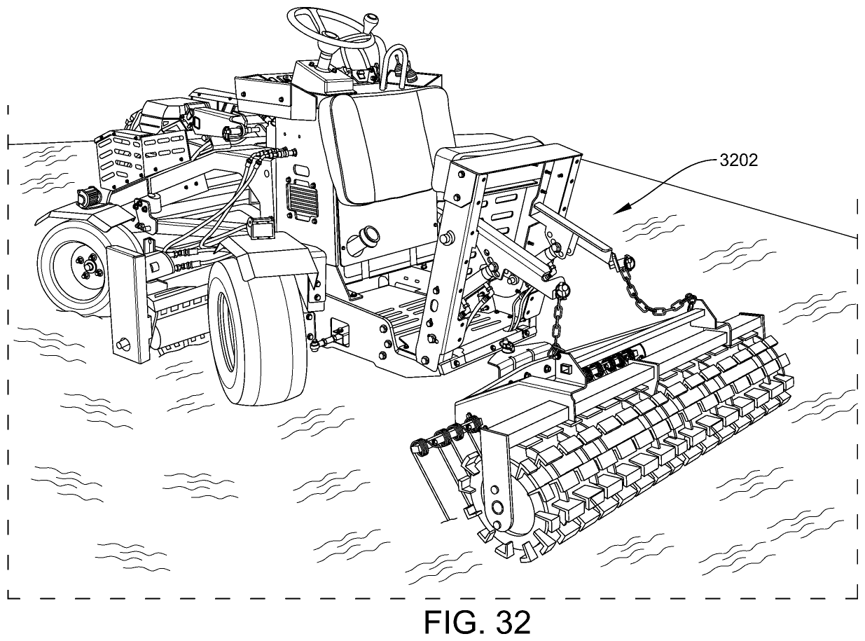

FIGS. 31, 32, and 33 depict other embodiments of the vehicle 100. In the FIGS. 31 and 32 example, the vehicle 100 includes first attachment 3102 positioned between the forward and rearward wheels and a second attachment 3104 positioned rearward of the rearward wheels. Such attachments may be referred to in the art as “rakes” or “drags.” The first attachment, as shown in the illustrated embodiment, may have a Harley rake. The second attachment, as shown in the illustrated embodiment, may have a tine and/or roller (e.g., compactor). Other attachments, however, are contemplated for the first and/or second attachments such as sprayers, spreaders, aerators, dethatchers, seeders, and/or mowers (e.g., deck(s) and blades and/or reel-style).

A Harley rake is preferably powered to rotate, such as using hydraulic power. For example, the Harley rake is optionally connected to and configured to receive power from the hydraulic system 705. As illustrated, the Harley rake is mounted between the front wheels and the rear wheels; however, it could be positioned in front of the forward wheels and/or behind the rearward wheels. The Harley rake is configured to break up the ground, level the ground, regrade gravel and/or dirt, and/or prepare the ground for another process such as leveling, compacting, and/or seeding among other examples.

Positioned behind the rear wheels of the vehicle illustrated in FIGS. 31 and 32 is a drag having coil tines and a rolling compactor. Advantageously, such a drag can help cultivate and pack the surface. Similar drags may also include a leveling bar. Other drags are envisioned depending on the use and/or user preferences. For instance, the draft behind the vehicle may include and/or be a drag harrow or “seeding drag”. As will be appreciated by those of skill in the art, a seeding drag can increase the contact between broadcasted seed and the soil.

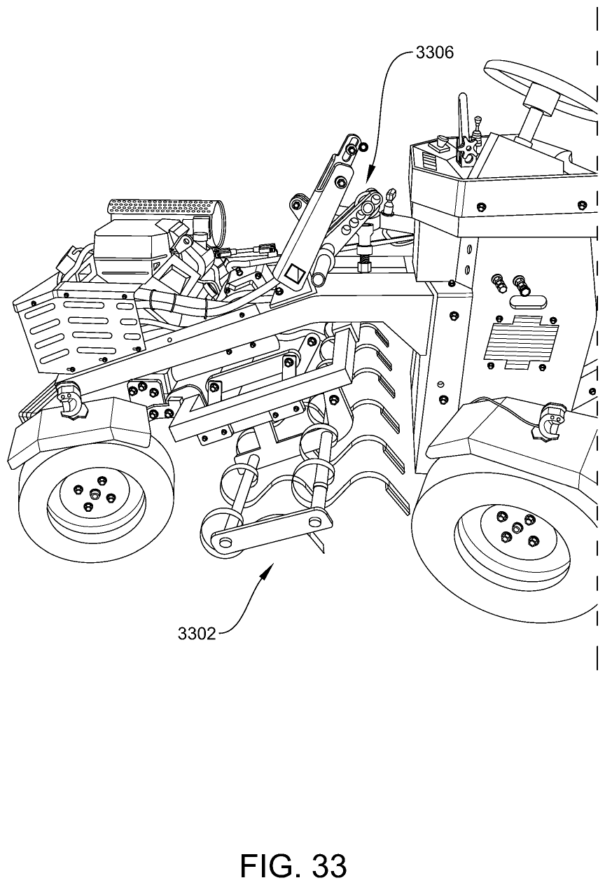

In the FIG. 33 example, the vehicle 100 includes an S-tine attachment 3302, in this instance, mounted between the front wheels and the rear wheels but which could be mounted in front of or behind the vehicle as well. Such attachments, as will be appreciated by those of ordinary skill in the art, may be used to cultivate (e.g., loosen) compacted soil, such as for preparing the ground for seeding, fertilizing, and/or adding top dressing.

As should be appreciated, the vehicle 100 is configured to utilize one or more attachments (e.g., tools) in front of the forward wheels, behind the rearward wheels, and/or between the forward and rearward wheels. The vehicle may also include any of the attachments of other embodiments disclosed herein. For instance, the vehicle 100 may include a spreader assembly 117, a boom sprayer 120, a plow blade, a bucket, a winch, a grader box, and/or a tiller as some examples. For instance, the vehicle 100 may include a tool mounted on the forward end in the example shown in FIGS. 1 through 4. In some embodiments, the vehicle includes a tool between the front wheels and the rear wheels, such as the boom sprayer 120, a Harley rake, an aeration head, a rotary broom, a mower, a slit seeder, and/or other tools. Further, as some additional examples, the vehicle 100 can include a seeding drag, a Harley rake, a soil prep head, a tine seeding head, a grader box, and/or other tools that are mounted on and/or dragged behind the rear of the vehicle.

As should be appreciated, the vehicle 100 is configurable to perform a variety of tasks. The vehicle 100 supports a variety of types and mounting positions for the attachments on the vehicle 100 so as to enable the vehicle 100 to perform customized combinations of tasks. In some embodiments, the vehicle 100 includes a combination of attachments used for maintaining lawns, sports fields, golf courses, and/or other areas such as equine areas. For example, the vehicle can include an aerating head for aerating (e.g., coring or spiking) the ground, a spreader for broadcasting (e.g., dropping) seed, and a sprayer for dispersing water or pesticide. As another example, the vehicle 100 can include a spreader to disperse top dressing (i.e., soil, sand, compost, etc.), a leveler or sweeper to level and/or distribute the top dressing, and a rear drag for further leveling and/or compacting the top dressing, just as non-limiting example. As yet another example, the vehicle 100 can include an aeration head to aerate the ground, a spreader to disperse the top dressing, and a rear drag for leveling and/or compacting the top dressing.

In another embodiment, the vehicle 100 can be configured for maintaining a dirt track and/or arena, such as an indoor or outdoor equine area. For instance, the vehicle 100 can include a rake for loosening the surface, a leveler for leveling the surface, a compactor for compacting the surface, and/or a boom sprayer 100 for hydrating the surface. In additional embodiments, the vehicle 100 can include a combination of attachments configured for adding material, removing material, and/or regrading material on a surface, such as gravel, sand, dirt, compost, and/or other loose material. For instance, the vehicle 100 can include a bucket, a grader box, a Harley rake, a drag mat, a leveling bar, and/or other tools. Further, the vehicle 100 can include a combination of attachments configured for plowing and/or seeding, such as a tiller, a slit seeder, a seeding drag, a tine seeding head, and/or other tools.

Preferably the vehicles shown and described with reference to FIGS. 31-33 are all-wheel steer and/or all-wheel-drive vehicles such as those disclosed elsewhere in the present disclosure. Advantageously, the vehicles shown and described with reference to FIGS. 31-33 can position the engine over the forward wheels of the vehicle. With the operator being positioned over and/or reward of the rearward wheels, this position can aid in distributing the weight of the vehicle more evenly across the forward and rearward wheels than existing vehicles, particularly skid-steer vehicles which often will lift their forward wheels off the ground when turning and/or accelerating quickly. Additionally, by positioning the motor over the forward wheels and spreading the forward wheels from the rearward wheels, relief is provided to lift vertically an attachment positioned between the forward and rearward wheels (see FIG. 33).

Preferably, the vehicle includes hydraulic actuators to lift attachments above the surface supporting the vehicle (e.g., the ground) whether the attachment(s) is/are forward of the forward wheels, between the forward and rearward wheels, and/or rearward of the rearward wheels. For example, lifting arm assembly 3202 in FIG. 32 is configured to lift the attachment positioned rearward of the rearward wheels, and lifting arm assembly 3306 in FIG. 33 is configured to lift the attachment positioned between the forward and rearward wheels.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “up”, “down”, “top”, “bottom”, “left”, “right”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The following numbered clauses set out specific embodiments that may be useful in understanding the present invention:

1. A vehicle, comprising:
a frame, a front set of wheels, and a rear set of wheels spaced rearward of the front set of wheels;
wherein the front and rear sets of wheels are driven and steerable;
wherein at least a first hydraulic cylinder is arranged to articulate at least a first wheel of the front set of wheels;
wherein at least a second hydraulic cylinder is arranged to articulate at least a second wheel of the rear set of wheels;
wherein at least one of the first and second hydraulic cylinders is a rephasing cylinder; and
wherein the first hydraulic cylinder is in hydraulic communication with the second hydraulic cylinder.

2. The vehicle of clause 1, wherein the first and second hydraulic cylinders are arranged to articulate the second wheel in a direction opposing the first wheel such that when the first hydraulic cylinder articulates the first wheel in a first direction the second hydraulic cylinder articulates the second wheel in a second direction that is opposite the first direction.

3. The vehicle of any preceding clause, wherein at least a first motor is arranged to rotate the first wheel and a second motor is arranged to rotate the second wheel.

4. The vehicle of any preceding clause, wherein the first and second motors are hydraulic motors.

5. The vehicle of any preceding clause, comprising a front axle disposed between and connected to each of the wheels of the front set of wheels;
wherein the front axle extends from a first end to a second end and rotates around a longitudinal axis of the vehicle such that as the first end of axle raises the second end of the axle lowers.

6. The vehicle of any preceding clause, wherein the first wheel is mounted to the front axle via a front axle outer joint kingpin, and wherein the first wheel pivots about the front axle outer joint kingpin upon actuation by the first hydraulic cylinder.

7. The vehicle of any preceding clause, comprising a rear axle disposed between and connected to each of the wheels of the rear set of wheels;
wherein the second wheel is mounted to the rear axle via a rear axle outer joint kingpin, and wherein the second wheel pivots about the rear axle outer joint kingpin upon actuation by the second hydraulic cylinder.

8. The vehicle of any preceding clause, further comprising:
a standing platform disposed rearward of the front set of wheels;
wherein during operation of the vehicle an operator stands on the platform.

9. The vehicle of any preceding clause, comprising a steering wheel positioned forward of the standing platform and operable to control the first and second hydraulic cylinders to steer the vehicle.

10. The vehicle of any preceding clause, comprising a redundant foot control positioned near the standing platform and operable to control the forward and/or reverse speed of the vehicle.

11. The vehicle of any preceding clause, wherein the vehicle includes at least one liquid tank and a boom sprayer in fluid communication with one another.

12. The vehicle of any preceding clause, wherein the at least one liquid tank is optionally rotatable to an open position to allow easy access to the internal components of the vehicle during maintenance.

13. The vehicle of any preceding clause, wherein the at least one optionally rotatable liquid tank is supported and locked in a closed position by a support arm and locking mechanism, respectively; and
wherein the at least one optionally rotatable liquid tank is supported in an open position by a support leg.

14. The vehicle of any preceding clause, wherein the boom sprayer is positioned forward of the front set of wheels.

15. The vehicle of any preceding clause, wherein the vehicle includes a granular spreader and a hopper arranged to provide granular material to the granular spreader.

16. The vehicle of any preceding clause, wherein the hopper includes an articulatable gate configured to control the flow of granular material from the hopper to the granular spreader.

17. The vehicle of any preceding clause, wherein the articulatable gate opens and closes as a function of the ground speed of the vehicle.

18. The vehicle of any preceding clause, wherein the articulatable gate is controlled by manual inputs of an operator of the vehicle.

19. The vehicle of any preceding clause, wherein the rotational speed of the granular spreader is a function of the ground speed of the vehicle.

20. The vehicle of any preceding clause, wherein the granular spreader is translatable along a horizontal plane to alter the broadcast pattern of the granular material being spread by the granular spreader.

21. The vehicle of any preceding clause, wherein the horizontal translation of the granular spreader is controlled by manual inputs of an operator of the vehicle.

22. The vehicle of any preceding clause, further comprising a sliding tank assembly mounted on rails integrated with the frame, wherein the tank slides laterally away from the chassis for maintenance.

23. The vehicle of clause 22, wherein the sliding tank assembly includes locking rails and a hydraulic assist, and a support leg deployable upon sliding.

24. The vehicle of any preceding clause, further comprising a modular attachment system for ground-engaging tools selected from the group consisting of a Harley rake, tine and roller compactor, and S-tine attachment.

25. The vehicle of clause 24, wherein the attachments include adjustable depth controls.

26. The vehicle of any preceding clause, further comprising a hydraulic lifting arm assembly with pivoting arms configured to lift attachments positioned between the wheels or rearward thereof.

27. The vehicle of clause 26, wherein the lifting arm assembly integrates with the frame and hydraulic system for raising attachments to provide ground clearance.

28. The vehicle of any preceding clause, wherein the motor is positioned over the front set of wheels.

29. The vehicle of any preceding clause, configured for equine arena maintenance with a rake and compactor.

30. The vehicle of any preceding clause, configured for golf course maintenance with an aerator and seeder.

31. The vehicle of any preceding clause, further comprising user-selectable control presets for attachment operations.

32. The vehicle of any preceding clause, wherein attachments are scalable for small or large sites.

### Glossary of Terms

The language used in the claims and the written description is to only have its plain and ordinary meaning, except for terms explicitly defined below. Such plain and ordinary meaning is defined here as inclusive of all consistent dictionary definitions from the most recently published (on the filing date of this document) general purpose Merriam-Webster dictionary.

As used in the claims and the specification, the following terms have the following defined meanings:

“And/or” is inclusive here, meaning “and” as well as “or”. For example, “P and/or Q” encompasses, P, Q, and P with Q; and, such “P and/or Q” may include other elements as well.

“Axially” means here relating to or forming an axis, wherein an axis is a fixed linear reference line, in this case axis A-A shown in the drawing figures and the axis along which the parts are moved with respect to each other to connect them together.

“Brake” generally refers to a device for arresting and/or preventing the motion of a mechanism usually via friction, electromagnetic, and/or other forces. Brakes for example can include equipment in automobiles, bicycles, or other vehicles that are used to slow down and/or stop the vehicle. In other words, a brake is a mechanical device that inhibits motion by absorbing energy from a moving system. The brake can be for example used for slowing or stopping a moving vehicle, wheel, and/or axle, or to prevent its motion. Most often, this is accomplished by friction. Types of brakes include frictional, pressure, and/or electromagnetic type braking systems. Frictional brakes for instance can include caliper, drum, and/or disc drakes. Electromagnetic braking systems for example can include electrical motor/generators found in regenerative braking systems.

“Couple” or “Coupled” generally refers to an indirect and/or direct connection between the identified elements, components, and/or objects. Often the manner of the coupling will be related specifically to the manner in which the two coupled elements interact.

“Electric Motor” generally refers to an electrical machine that converts electrical energy into mechanical energy. Normally, but not always, electric motors operate through the interaction between one or more magnetic fields in the motor and winding currents to generate force in the form of rotation. Electric motors can be powered by direct current (DC) sources, such as from batteries, motor vehicles, and/or rectifiers, or by alternating current (AC) sources, such as a power grid, inverters, and/or electrical generators. An electric generator can (but not always) be mechanically identical to an electric motor, but operates in the reverse direction, accepting mechanical energy and converting the mechanical energy into electrical energy.

“Fastener” generally refers to a hardware device that mechanically joins or otherwise affixes two or more objects together. By way of non-limiting examples, the fastener can include bolts, dowels, nails, nuts, pegs, pins, rivets, screws, hook and loop fasteners, and snap fasteners, to just name a few.

“Frame” generally refers to a structure that forms part of an object and gives strength and/or shape to the object.

“Ground-manipulating attachment” generally refers to a tool or implement configured to engage and manipulate a ground surface during vehicle operation, such as by loosening, aerating, leveling, grading, compacting, raking, seeding, spraying, or cultivating soil, turf, gravel, or similar materials. By way of non-limiting examples, a ground-manipulating attachment can include a Harley rake, a tine and roller compactor, an S-tine cultivator, a drag harrow, a seeding drag, a slit seeder, a boom sprayer, a grader box, or an aerator, as illustrated in FIGS. 31-33 and described herein.

“Longitudinal” generally refers to the length or lengthwise dimension of an object, rather than across.

“Motor” generally refers to a machine that supplies motive power for a device with moving parts. The motor can include rotor and linear type motors. The motor can be powered in any number of ways, such as via electricity, internal combustion, pneumatics, and/or hydraulic power sources. By way of non-limiting examples, the motor can include a servomotor, a pneumatic motor, a hydraulic motor, a steam engine, a pneumatic piston, a hydraulic piston, and/or an internal combustion engine.

“Powertrain” generally refers to devices and/or systems used to transform stored energy into kinetic energy for propulsion purposes. The powertrain can include multiple power sources and can be used in non-wheel-based vehicles. By way of non-limiting examples, the stored energy sources can include chemical, solar, nuclear, electrical, electrochemical, kinetic, and/or other potential energy sources. For example, the powertrain in a motor vehicle includes the devices that generate power and deliver the power to the road surface, water, and/or air. These devices in the powertrain include engines, motors, transmissions, drive shafts, differentials, and/or final drive components (e.g., drive wheels, continuous tracks, propeller, thrusters, etc.).

“Steering System” generally refers to one or more devices and/or linkages that allow a vehicle to follow a desired course. By way of non-limiting examples, the steering system can include active, passive, rear wheel, front wheel, four-wheel, power, steer-by-wire, articulated, speed sensitive, differential, crab, hydraulic, rack and pinion, worm and sector, recirculating ball, Ackerman, and/or Bell-crank type systems, to name just a few.

1. A vehicle, comprising:
a frame, a front set of wheels, and a rear set of wheels spaced rearward of the front set of wheels;
wherein the front and rear sets of wheels are driven and steerable;
wherein at least a first hydraulic cylinder is arranged to articulate at least a first wheel of the front set of wheels;
wherein at least a second hydraulic cylinder is arranged to articulate at least a second wheel of the rear set of wheels;
wherein the first hydraulic cylinder is in hydraulic communication with the second hydraulic cylinder; and
a first ground-manipulating attachment positioned between the front set of wheels and the rear set of wheels and a second ground-manipulating attachment positioned rearward of the rear set of wheels.

2. The vehicle of claim 1, wherein the first and second hydraulic cylinders are arranged to articulate the second wheel in a direction opposing articulation of the first wheel such that when the first hydraulic cylinder articulates the first wheel in a first direction relative to the frame, the second hydraulic cylinder articulates the second wheel in a second direction opposite the first direction relative to the frame.

3. The vehicle of claim 1, wherein at least a first motor is arranged to drive the first wheel and at least a second motor is arranged to drive the second wheel, and wherein the first and second motors are hydraulic motors.

4. The vehicle of claim 1, further comprising a front axle disposed between and connected to each wheel of the front set of wheels, wherein the front axle pivots about a longitudinal axis of the vehicle such that a first end of the front axle raises as a second end of the front axle lowers.

5. The vehicle of claim 4, wherein the first wheel mounts to the front axle via a front axle outer joint kingpin, and the first wheel pivots about the front axle outer joint kingpin upon actuation by the first hydraulic cylinder.

6. The vehicle of claim 1, further comprising a standing platform disposed rearward of the front set of wheels, wherein an operator stands on the standing platform during operation of the vehicle.

7. The vehicle of claim 6, further comprising a steering wheel positioned forward of the standing platform and operable to control the first and second hydraulic cylinders to steer the vehicle.

8. The vehicle of claim 6, further comprising a foot control positioned adjacent the standing platform and operable to control forward and/or reverse speed of the vehicle.

9. The vehicle of claim 1, wherein a motor of a powertrain is positioned over the front set of wheels.

10. The vehicle of claim 1, further comprising a hydraulic lifting arm assembly configured to lift at least one of the first ground-manipulating attachment or the second ground-manipulating attachment relative to the frame, wherein the hydraulic lifting arm assembly includes at least one pivoting arm and hydraulic cylinder.

11. The vehicle of claim 1, wherein the first ground-manipulating attachment comprises a Harley rake and the second ground-manipulating attachment comprises a tine and roller compactor.

12. A vehicle, comprising:
a frame, a front set of wheels, and a rear set of wheels spaced rearward of the front set of wheels;
wherein the front and rear sets of wheels are driven and steerable;
wherein at least a first hydraulic cylinder is arranged to articulate at least a first wheel of the front set of wheels;
wherein at least a second hydraulic cylinder is arranged to articulate at least a second wheel of the rear set of wheels;
wherein the first hydraulic cylinder is in hydraulic communication with the second hydraulic cylinder; and
at least one tank selectively slidable laterally away from the frame on a rail system to provide access to internal components of the vehicle for maintenance.

13. The vehicle of claim 12, wherein the rail system includes locking mechanisms to secure the at least one tank in an operational position.

14. The vehicle of claim 13, further comprising a support leg deployable to support the at least one tank in an extended position.

15. The vehicle of claim 12, further comprising a boom sprayer in fluid communication with the at least one tank.

16. The vehicle of claim 15, wherein the boom sprayer is positioned forward of the front set of wheels.

17. The vehicle of claim 12, further comprising a standing platform disposed rearward of the front set of wheels, wherein an operator stands on the standing platform during operation of the vehicle.

18. The vehicle of claim 17, further comprising a steering wheel positioned forward of the standing platform and operable to control the first and second hydraulic cylinders to steer the vehicle.

19. The vehicle of claim 12, further comprising a hopper with an articulatable gate configured to control flow of granular material to a spreader as a function of vehicle speed.

20. The vehicle of claim 12, further comprising a hydraulic assist powered by the hydraulic system and configured to facilitate sliding of the at least one tank along the rail system.
